(19) United States
(12) Patent Application Publication
(10) Pub. No.: US 2024/0071081 A1
(43) Pub. Date: Feb. 29, 2024

(54) INCIDENT SLICING FOR PREVENTION OF SOCIAL AND VIRTUAL THREATS

(71) Applicant: AT&T Intellectual Property I, L.P., Atlanta, GA (US)

(72) Inventors: Rashmi Palamadai, Naperville, IL (US); Nigel Bradley, Canton, GA (US)

(21) Appl. No.: 17/823,590

(22) Filed: Aug. 31, 2022

(51) Int. Cl. G06V 20/52; G06T 19/00; G06V 40/10; H04L 67/50

(52) U.S. Cl. CPC G06V 20/52; G06T 19/006; G06V 40/103; H04L 67/535

(57) ABSTRACT

Techniques are described that facilitate detecting and minimizing social and virtual threats using a communication network. In one example embodiment, method comprises identifying, by a system comprising a processor, incident locations associated with incident risks with based on user activities associated with the incident locations satisfying an incident risk criterion. The method further comprises determining, by the system, targeted surveillance protocols for the incident locations based on the identifying, comprising determining the targeted surveillance protocols based on respective types of the incident risks associated with the incident locations and respectively severities of the incident risks, wherein the targeted surveillance protocols specify usage of respective surveillance services performed by respective devices connected via a communication network. The method further comprises controlling, by the system, respective performances of the targeted surveillance protocols utilizing the respective surveillance services performed by the respective devices.

### TECHNICAL FIELD

This disclosure relates to computer-implemented techniques that facilitate detecting and minimizing, or reducing an impact of, social and virtual threats or incidents using a communication network.

### BACKGROUND

People can encounter potentially dangerous individuals unknowingly in both real-world and virtual reality environments. In some cases, the threatening individual may not be aware that they are behaving in what is perceived to be a dangerous way. Being able to be advised of a potential threatening individual in one's vicinity or virtual environment would assist in quick evacuation, and/or direct intervention with the threatening individual.

### DESCRIPTION OF THE DRAWINGS

FIG. 1 illustrates an example, high-level architecture diagram of a non-limiting system that facilitates detecting and minimizing social and virtual incidents using a communication network in accordance with one or more embodiments of the disclosed subject matter.

FIG. 2 illustrates an example, non-limiting surveillance system that facilitates detecting and minimizing social and virtual incident using a communication network in accordance with one or more embodiments of the disclosed subject matter.

FIG. 3 presents an example incident assessment component in accordance with one or more embodiments of the disclosed subject matter.

FIG. 4 presents an example surveillance protocol assessment component in accordance with one or more embodiments of the disclosed subject matter.

FIG. 5 presents an example surveillance protocol execution component in accordance with one or more embodiments of the disclosed subject matter.

FIG. 6 illustrates a high-level flow diagram of an example computer-implemented process that facilitates detecting and minimizing social and virtual threats using a communication network in accordance with one or more embodiments of the disclosed subject matter.

FIG. 7 illustrates a high-level flow diagram of another example computer-implemented process that facilitates detecting and minimizing social and virtual threats using a communication network in accordance with one or more embodiments of the disclosed subject matter.

FIG. 8 illustrates a block diagram of an example, non-limiting operating environment in which one or more embodiments described herein can be facilitated.

FIG. 9 illustrates a block diagram of another example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, or in this Detailed Description section.

The evolution of wireless communication networks has resulted in an interconnected world of communication devices capable of capturing and collecting a wide range of information about individuals and their environments in real-time as they move about their day in the real or physical world. For example, a majority of people carry smartphones with them wherever they go that can provide information about their location, movement patterns, and environment in association with usage of communication services provisioned via one or more communication networks and corresponding network carriers. In addition, wearable user devices such as smartwatches and augmented reality (AR) headsets (or googles, glasses, contact lenses, etc.) that can provide additional information about the wearer and their environment, such as biometric feedback and live image data respectively, are becoming increasingly popular. At the same time, intelligent security monitoring equipment (e.g., cameras, audio capture devices, motion capture devices, and others) capable of capturing and monitoring human behavior and activity are increasingly being used in both private and public environments. Furthermore, advancements in machine learning (ML) and artificial intelligence (AI) have facilitated processing such massive amounts of diverse information about individuals to provide a wide range of applications that facilitate daily user activities and decision making in an automated and personalized way.

The disclosed subject matter leverages these tools to facilitate detecting and minimizing social and virtual incidents attributed to human activity or behavior using a communication network. In this regard, the term “incident” as used herein can refer to any type of human behavior or activity in the real-world or a virtual world (i.e., the Metaverse™ and the like) that could be considered non-conforming to a social or societal construct of the corresponding environment, such as behavior or activity that violates societal rules and/or norms, from criminal activity to dressing, speaking or otherwise behaving in a manner considered inappropriate for the environment and/or context. In other words, an incident can include any type of human behavior that “breaks the rules,” wherein the rules can be predefined and vary based on the environment and context. For instance, an incident or potential incident could involve a person or group of people (e.g., two more) behaving inappropriately towards another person, wherein what constitutes “inappropriate,” can be predefined based on the environment and context. Incidents associated with a virtual world can be based on the behavior or activity of users as expressed via their representative avatars. An incident can also refer to any human behavior or activity that may be considered to impose a risk of injury or harm to oneself or others, including physical and/or mental injury to individuals and/or property.

To facilitate this end, one or more embodiments of the disclosed subject matter are directed to a surveillance system associated with a communication network that monitors user activity and behavior in real-world environments based on user activity information captured and reported to the surveillance system via the communication network by various devices and systems connected to the communication network. The user activity information can include any information that identifies, describes or indicates information regarding the identity, appearance, behavior and/or activity of a person or group of people relative to an environment or location. In various embodiments, the devices and/or systems can include security monitoring devices deployed throughout the real-world environments that capture image data (e.g., video and/or still images), audio data, motion data, and other sensory data regarding user behavior and activity associated with the environments (e.g., via one or more cameras, audio recording devices, motion sensors, thermal sensors, and other types of sensors) and provide the captured data to the surveillance system via the communication network. The security monitoring devices can include fixed location devices as well as mobile devices attached to vehicles (e.g., automobiles, drones and other aircraft, boats, etc.). The surveillance system can further process the received sensory data (e.g., image data, audio data, motion data, and other sensory data) using corresponding automated data processing technologies that can interpret the sensory data and correlate the sensory data to defined human behaviors, activities and attributes (e.g., using object detection/recognition technologies, facial recognition technologies, motion recognition technologies, gesture recognition technologies, and so on).

Additionally, or alternatively, the surveillance system can employ a user reporting incident mechanism to identify or facilitate identifying incidents via which users can submit incident reports regarding incidents or potential incidents observed in their environments via their connected user equipment (e.g., smartphones, smart watches, wearable devices, personal computers, etc.). For example, via their user equipment, users can submit incident reports to the surveillance system comprising information identifying or indicating an incident or potential incent, the location or environment of the incident or potential incident, the person or persons involved in the incident, and any other relevant information describing the incident. The surveillance system can provide rewards or incentives to user for submitting incident reports, such as discounts on subscription services provided by the communication network, discounts on user equipment hardware and/or software upgrades, and the like. The surveillance system can also evaluate the credibility of respective users providing incident reports in association with determining the validity of the respective incident reports and incorporate a user credibility rating function that regularly determines, and updates user credibility ratings based on the validity of their respective reports.

In one or more embodiments, the surveillance system can identify incident locations or potential incident location based on analysis of received user activity data reported via respective security monitoring devices and defined information (e.g., rules, algorithms, models, etc.) correlating certain user behaviors, activities and/or attributes to incidents. Additionally, or alternatively, the surveillance system can identify incident locations and/or potential incident locations based on user provided incident reports. The surveillance system can employ AI and ML techniques to facilitate identifying, classifying and characterizing incident locations based on analysis of the user activity information, the incident reports, historical user activity information associated with different user behaviors, locations and contexts, and domain knowledge correlating various parameters correlating user activities, behaviors and attributes in different environments/locations and contexts to defined incident types. In some embodiments, the surveillance system can employ one or more classification models to classify incidents or potential incidents according to defined incident types or categories based on analysis of the received user activity data provided by the security monitoring devices and/or the information included in user provided incident reports. The incident types or categories can include a wide range of different types of incidents depending on the types of incidents the surveillance system is adapted to monitor and evaluate, including various types of criminal activity and non-criminal activity that violates any predefined rules for an environment and context (e.g., dressing inappropriately, speaking inappropriately, etc.) and/or behavior or activity determined to impose a risk to oneself or others.

As used herein, an incident location refers to a specific location or environment (e.g., area) in the real-world and/or virtual word associated with occurrence or potential occurrence of an incident. In various embodiments an incident location can correspond to a current location or environment where an incident is occurring or potentially occurring in real-time (i.e., the current location of the person or group of people performing an activity or behavior that corresponds to an incident or a potential incident). Information identifying a real-world location associated with a current incident can be determined based on the location of the device or devices from which user activity data for which the incident is based was received or reported and/or based on the location of a device associated with the offending person or persons (e.g., user equipment worn or carried by the offending person) and using various known location detection/tracking means (e.g., global positioning system (GPS) means, indoor positioning system technology, etc.). Information regarding a virtual world incident location can relate to a virtual room or environment included in the virtual world and/or a real-world location of the user device employed to access the virtual room or environment.

The terms “location,” and “environment,” are used herein interchangeably unless context warrants particular distinction amounts the terms. In this regard, a location typically refers a static location parameter represented by a defined or known location value, such as global positioning system (GPS) location, a defined address, a defined physical structure or place represented by a defined address, a defined indoor position, or a defined geographical area (e.g., zip code, cell site, etc.). In some contexts, the term environment can more particularly refer to an environment associated with a location, wherein some locations may be associated with a plurality of different environments (e.g., different rooms or areas inside a building, different rooms or areas associated with a particular virtual world or sub-world, etc.), and wherein the environment or conditions associated with the environment can vary for some locations (e.g., based on user activity, environmental conditions, time, events associated with the environment, etc.).

In some embodiments, the surveillance system can characterize some locations as historical incident locations based on known associations of the locations with incidents or a high risk of incidents in the past. For example, certain environments may be known to have a higher rate or risk/rate of incidents based on known risks associated with the locations (e.g., attributed to the natural landscape, weather, activities performed at the locations, etc.) historical user activity at the locations, such as certain neighborhoods, buildings, event locations, crowded areas (e.g., airports, stadiums), certain natural environments (e.g., dangerous hiking trails, rapid waters, etc.) and so on. The surveillance system can employ AI and ML techniques to facilitate identifying, classifying and characterizing historical incident locations based on analysis of the historical user activity information and additional information regarding incidents associated with the locations provided by various sources.

The surveillance system can further evaluate and characterize incident locations and/or corresponding incidents associated with the locations based on respective types of the incidents (i.e., the particular user activity of behavior corresponding to the incident) and various other factors that influence how to respond to the incidents in an optimal manner. For example, the various other factors can relate to (but are not limited to), the location of the incident, context of the incident, the individual or individuals involved (e.g., identities, known profiles and history of the individual/individuals, number of individuals, user demographics, etc.), the probability of escalation or occurrence of the incident, the amount and validity of received incident reports about the incident, and known and forecasted risk associated with the incident. In some embodiments, the surveillance system can determine or infer (e.g., using ML and/or AI) a measure of severity of the respective incidents based the types of the incidents and one or more of these factors (among other factors). In this regard, the surveillance system can analyze all received and relevant information about an incident to understand what the incident entails, who is involved, level of severity of the incident, the risk associated with the incident, the context of the incident, and so on, to facilitate determining an optimal game plan for responding to the incident. This evaluation and characterization of respective incidents can incorporate predefined rules, algorithms and/or models, including ML and AI algorithms/models.

In various embodiments, in association with determining how to respond to the incidents in an optimal manner, the surveillance system can determine targeted surveillance protocols related to monitoring incident locations and corresponding incidents associated with the locations and performing actions that facilitate minimizing occurrence of the corresponding incidents based on the incident types, severities and/or one or more of the various factors (among others). To facilitate this end, the surveillance system can employ ML and AI to determine the or facilitated determining the targeted surveillance protocols based on relevant information about the respective incidents, including the incident type, severity, the location, context of the individual, the individual or individuals involved (e.g., identities, known profiles and history of the individual/individuals, number of individuals, user demographics, etc.), the probability of escalation or occurrence of the incident, the amount and validity of received incident reports about the incident, and known and forecasted risks associated with the incident. In this regard, the targeted surveillance protocols can be tailored to the context and surveillance service needs associated with the respective incidents as the incidents arise and can be dynamically adapted to account for changes in the escalation and/or de-escalation of the incidents as they are progressively monitored. The surveillance system can further execute and/or control execution or implementation of the targeted surveillance protocols.

In this regard, the targeted surveillance protocols can involve utilizing various surveillance services performed by and/or facilitated by the surveillance system and/or the communication network. The surveillance services can include essentially any task or function performed or facilitated by the surveillance system and/or the communication network related to monitoring user activity at incident locations, identifying and characterizing incidents, determining optimal responses to the incidents, and performing or facilitating performing the responses. For example, the surveillance services involve performance of tasks related to tailoring capture and provision of user activity and environment information from security monitoring devices (but not limited to): selecting the optimal security monitoring device or devices to capture and provide the activity information for a particular incident and location (e.g., based on relative to position/location within the incident environment, device type, device capabilities, etc.), adding and/or activating additional security monitoring devices, remotely controlling the security monitoring devices with respect to device activation and operating parameters and settings (e.g., related to data capture rate, data capture quality, data capture type, zoom levels, volume levels, etc.), remotely controlling device position, orientation (e.g., view angle as applied to cameras) and movement (e.g., with respect to drone cameras and other security monitoring devices attached to remotely controllable mobile machines/vehicles), and determining and controlling optimal scheduling parameters used to communicate data between the security monitoring devices and network equipment of the communication network (i.e., wireless connection uplink/downlink parameters, transmission quality parameters, transmission rate parameters, reliability parameters, etc.). The surveillance services can also involve tasks related to tailoring processing the user activity information provided by security monitoring devices and processing user provided incident reports (e.g., in association with analyzing the user activity data to identify and characterize incidents and determining and updating surveillance protocols applied for respective incidents), including determining appropriate models/algorithms to run, databases to access, and third-party services to call (e.g., criminal background checking services, facial recognition/identity verification services), and determining distribution of computer processing resources (e.g., with respect to amount, type, speed, power, etc.) allocated to performing the analysis for the respective tasks based on need, priority, severity of the respective incidents, progression of the respective incidents, and so on.

The surveillance services can also relate to obtaining incident reports, including identifying relevant users in an environment to request provision of incident reports comprising information about a potential or detected incident. For example, in association with determining an optimal surveillance protocol for responding to a potential incident or incident the surveillance system can identify and select relevant users to provide incident report information about the incident (e.g., descriptive text, image data (e.g., video, live streaming video feeds, audio data, etc.) based on their relative location (e.g., as a function of the location of the user equipment) to the incident location and/or activity (i.e., offending user or users) within the incident location, their user equipment capabilities, their user equipment battery levels, their user equipment connectivity status to the communication network, reporting credibility, and other relevant information about the users that may make them more or less suitable for providing information about the incident (e.g., demographic information, relationships/correlations with the offending user or users, role of the user in the environment/location (e.g., employee, visitor, home owner, etc.), preferences of the user, and so on). The surveillance system can further send the selected users requests (i.e., to user equipment of the respective users) for the corresponding incident reports via the communication network. The surveillance system can further facilitate controlling reception of the requested information via the communication network in a prioritized manner via determining and controlling optimal scheduling parameters used to communicate data between the security monitoring devices and network equipment of the communication network (i.e., wireless connection uplink/downlink parameters, transmission quality parameters, transmission rate parameters, reliability parameters, etc.).

The surveillance services can also include sending notifications and alerts to user equipment via the communication network regarding detected incidents, including the determining the appropriate entities to notify, timing of notification and the contents (i.e., the information disclosed) of the notifications. For example, surveillance system can send notifications to user equipment of offending individuals informing them they are flagged as a person of interest and being actively monitored. The surveillance system can also determine and recommend actions or behaviors for the offending user or user to perform that can minimize or prevent an incident and/or its associated risks and include these recommendations in the notifications. The surveillance system can also send notifications to other uses in the incident environment altering them about the detected incident or potential incident and provide information/recommendations regarding appropriate responsive actions precautions to take. For example, the surveillance system can monitor user movement and location (e.g., based on respective movement and/or location of their user equipment), detect presence of users within or near an incident location or environment (e.g., relative to a defined distance threshold), and notify the users accordingly (e.g., sending notifications to users informing them that they are located at or near environment associated with an incident or potential incident and include relevant information about incident or potential incident). The surveillance system can also identify other relevant entities regarding an incident, such as friends, family members, caregivers, etc. associated with the offending individual or individuals (e.g., via notification sent to user equipment and/or social media platforms), relevant authorities and emergency personnel, and/or any relevant entity that may perform a role related to minimizing or preventing the incident (e.g., notify bar owners in the area not to further serve an intoxicated individual flagged by the system).

The surveillance services can also include remotely controlling vehicles, remotely controlling physical access points (e.g., locking/opening doors, adapting access security protocols), remotely controlling other relevant internet of things (IoT) devices in a manner that facilitates minimizing or preventing and incident and/or associated risks. The surveillance services can also involve integrating with third-party systems to perform relevant actions determined to minimize or prevent incidents and/or their associated risks (e.g., integrating with finance systems to prevent usage of financial accounts for specific purchases such as preventing an intoxicated person from purchasing alcohol, blocking offending users from access to certain virtual environments, etc.) and various other responses that can be performed or facilitated by the surveillance system via the communication network to minimize or prevent incidents and/or their associated risks.

In this regard, many of the targeted surveillance protocols can involve utilizing various surveillance services performed by and/or facilitated by the surveillance system via the communication network using resources of the communication network. The resources can include logical and/or physical resources including and/or associated with network equipment, user equipment and security monitoring devices (e.g., including those already deployed at the incident locations and additional security monitoring device that may deployed depending on the security monitoring protocol applied). In some embodiments, the surveillance system itself can be owned/operated by the communication network provider and employ physical and/or logical resources of the communication network (e.g., computer processing resources, computer storage resources, etc.) to perform the various processing task associated with corresponding surveillance services. Thus, in various embodiments, in association with determining the targeted surveillance protocols and associated surveillance services utilized, the surveillance system can determine how to allocate the available resources of the communication network for performing the surveillance services based on the context and surveillance service needs associated with the respective locations and incidents as the incidents arise.

For example, the surveillance system can determine how to allocate respective amounts and respective speeds of respective computer processing hardware utilized by surveillance system and/or the communication network in association with performing the respective surveillance services. In another example, the surveillance system can determine optimal scheduling parameters (e.g., a transmission rate parameter, a latency level parameter, and a reliability level parameter, a quality parameter, etc.) that control a communication protocol associated sending user activity information by the security monitoring devices and/or user equipment to the network equipment. In another example, the surveillance system can determine security monitoring device performance information regarding a number of the security monitoring devices to activate, respective rates of data capture by the security monitoring devices and respective qualities of the data capture by the security monitoring devices.

The resource allocation can further account for the totality of all incent locations and associated incidents being monitored by the surveillance system in manner that prioritizes resource distribution and allocation based on need, severity and priority of the incidents. For example, in some embodiments, the surveillance system can rank respective incident locations based on respective types of incidents associated with the locations and respective severities of the incidents and allocate resources based on the ranking. In this regard, the rankings can reflect a measure of priority of the respective incident locations with respect to allocation of the systems resources (e.g., higher priority incident locations receiving priority allocation of the available resources with respect to amount and/or quality). The surveillance system can further regularly and dynamically update the resource allocation to account for changes in the escalation and/or de-escalation of the incidents and their corresponding rankings as they are progressively monitored. In this regard, the surveillance system can be employed to actively monitor and respond to incidents occurring at plurality of locations and environments (e.g., associated with a community, a city, a state, a country, the world, etc.) simultaneously in an automated and efficient manner tailored to the context of the respective incidents and in a manner that optimizes available system resources (e.g., of the communication network and the surveillance system) based on need.

Generally, reference to an “entity” or “user” is used herein to refer to a person/human being. However, the term “entity” as used herein can refer to a person, a group of people (e.g., including two or more), an animal, a machine/device or group of machines/devices. An entity can be represented by a user profile or account that can be associated with one or more systems and/or devices. The terms “algorithm” and “model” are used herein interchangeably unless context warrants particular distinction amongst the terms. The terms “artificial intelligence (AI) model” and “machine learning (ML) model” are used herein interchangeably unless context warrants particular distinction amongst the terms.

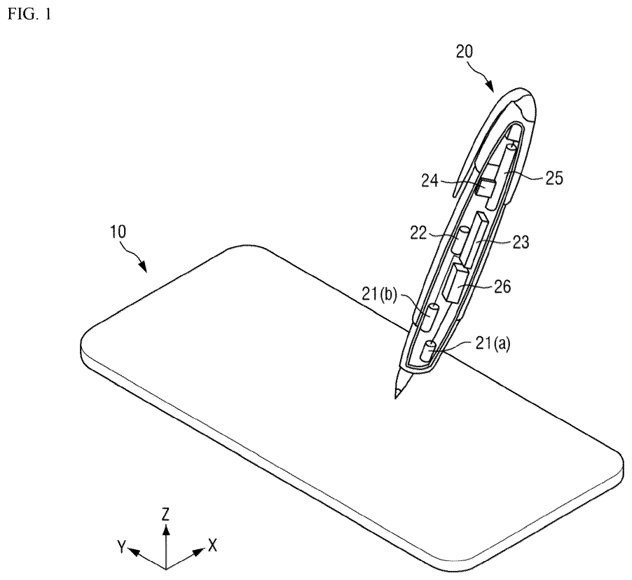

Embodiments of systems and devices described herein can include one or more machine-executable components or instructions embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. These computer/machine executable components or instructions (and other described herein) can be stored in memory associated with the one or more machines. The memory can further be operatively coupled to at least one processor, such that the components can be executed by the at least one processor to perform the operations described. In some embodiments, the memory can include anon-transitory machine-readable medium, comprising the executable components or instructions that, when executed by a processor, facilitate performance of operations described for the respective executable components. Examples of said and memory and processor as well as other suitable computer or computing-based elements, can be found with reference to FIG. 8 (e.g., processing unit 804 and system memory 806 respectively), and can be used in connection with implementing one or more of the systems or components shown and described in connection with FIG. 1, or other figures disclosed herein.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. In additional, it should be appreciated that various illustrations and system configurations are exemplary and not drawn to scale.

Turning now to the drawings, FIG. 1 illustrates an example, high-level architecture diagram of a non-limiting system 100 that facilitates detecting and minimizing social and virtual incidents using a communication network 110 in accordance with one or more embodiments of the disclosed subject matter. System 100 includes a variety of devices and computing systems that may be interconnected either directly and/or via a communication network 110. The devices can include various physical communication devices distributed throughout a real-world environment 102 capable of being monitored by the system 100, including network equipment (NE 104), user equipment (UE 106) and IoT devices 108. The NE 104 can also include additional network equipment (e.g., real and/or virtual devices/machines) of the communication network 110 associated with one or more non-physical layers of the communication network (e.g., network transport layers and/or network core layers, as described in greater detail below) that can include physical and logical network resources located in different locations (e.g., outside the real-world environment 102) and/or in the cloud. The real-world environment 102 depicted in system 100 corresponds to an example metropolitan environment including various business buildings, an airport, a stadium, a residential neighborhood, cars/vehicles (assumed roadways), and so one. It should be appreciated that the real-world environment 102 is merely exemplary and that system 100 can be employed to perform surveillance services for a multitude of different real-world environments and locations (e.g., as well as virtual environments).

The computing systems associated with system 100 can include various communication network provider systems 116 (e.g., core systems) that control various operations and services provisioned by the communication network 110, including the surveillance services disclosed herein (e.g., provided by and/or facilitated by surveillance system 120) and controlling distribution and allocation of resources of the communication network 110 (e.g., provided by and/or facilitated by the surveillance system 120 and resource management system 118). The computing systems can also include various other systems 114 accessible via the communication network 110 that can be used by the surveillance system 120 to gather relevant information related to monitoring, evaluating and responding to incidents, to communicate information with regarding detected incidents and potential incidents, and/or to interface with in association with performing responses to incidents (e.g., background checking systems, emergency services systems, health information systems, weather systems, social media systems, domain knowledge systems, financial systems, user credibility/trust rating systems, security monitoring device deployment systems, etc.).

The computing systems can include a virtual word system 112 that can provide one or more virtual reality (VR) environments (e.g., the Metaverse™ or the like) in which users can perform activities/behaviors that can be monitored and regulated by the surveillance system 120 in association with detecting and responding to incidents. The VR world system 112 can correspond to a VR gaming experience wherein users can be presented with a computer-generated imagery simulation of an environment in two-dimensions (2D) and/or three-dimensions (3D) that can be interacted with in a seemingly real or physical way by a person using special electronic equipment, such as a VR helmet, glasses, or googles, with a screen inside or gloves fitted with sensors. In some embodiments, 2D and/or 3D avatars can be used to represent users in a VR environment. For example, each user can interact with the VR environment from the perspective of a person immersed in the environment in a shared experience with other players or people being located within the immersive environment, wherein respective users are presented to one another. The respective players or users can be embodied as virtual avatars and interact with one another as avatars.

Depending on the virtual world system 112, the VR environment can include a plurality of different environments or worlds and sub-worlds with different characteristics, interactive functionality and access permissions (e.g., public and private environments). For example, in some implementations, the VR environments can correspond to real-world environments, such as 3D models of homes, stores and businesses, outdoor environments, and the like, via which users can interact with in VR in a same or similar manner as if they were actually located in those environments in the real-world. The VR environments can also correspond to essentially any non-real word environment capable of being fathomed and created by human imagine. The VR environments can also provide additional interactive capabilities that are facilitated by the computer-simulated environments, such as behaviors and activities of avatars that extend beyond the capabilities of humans and the physical world (e.g., flying, moving through walls/barriers, jumping between buildings, etc.). The VR environments can also be associated with a wide range of different rules and permissions that govern acceptable behavior/activity of users and/or appearance of their representative avatars in the VR environments, including rules or permissions that reflect corresponding real-world rules and permissions as well as unique rules and permissions tailored to specific VR environments. In various embodiments, the surveillance system 120 can facilitate detecting and responding to incidents associated with the virtual world system 112 based on the behaviors and/or activities of users as represented via their avatars in the VR environments and the corresponding rules and/or permissions associated with the respective VR environments that govern acceptable an unacceptable behaviors and activities of users in the VR environments.

In some embodiments, the non-limiting term communication device (or a similar term) is used. It can refer to any type of wired or wireless device that can communicate with another communication device in a wired or wireless communication system via one or more communication networks (e.g., communication network 110). In the regard, the NE 104, the UE 106, the IoTs 108, and respective devices (e.g., server devices or the like) employed by the virtual world system 112, other systems 114 and the communication network provider systems 116 (e.g., the resource management system 118 and the surveillance system 120) can respectively be or include communication devices.

Communication devices (e.g., NE 104, UE 106, IoTs 108, and respective server devices employed by the virtual world system 112, other systems and the communication network provider systems 116) can communicate information (e.g., voice and/or data traffic) to other communication devices via the communication network 110, which can comprise a core network that can operate to enable wireless communication between communication devices. For example, a wireless communication device (e.g., a mobile, cell or smart phone, an electronic tablet or pad, a personal computer, an IoT device, or another type of communication device) can connect to and communicate with a wireless communication network to communicate with another communication device connected to the wireless communication network or to another communication network (e.g., Internet Protocol (IP)-based network, such as the Internet) associated with (e.g., communicatively connected to) the wireless communication network. Communication devices can operate and communicate via wireless or wireline communication connections (e.g., communication links or channels) in a communication network to perform desired transfers of data (e.g., voice and/or data communications), utilize services, engage in transactions or other interactions, and/or perform other operations.

The term user equipment (UE) is used herein to refer to a communication device typically employed by a user (i.e., a person) in a real-world environment (e.g., real-world environment 102) capable of communicating with other communication devices via the communication 110. For example, the UE 106 can include mobile communication devices typically employed by users having wireless communication functionality, such as a mobile terminal, a cellular and/or smart phone, a tablet or pad (e.g., an electronic tablet or pad), an electronic notebook, a portable electronic gaming device, electronic eyeglasses and/or headwear (e.g., an augmented reality (AR) or virtual reality (VR) headset), and bodywear (e.g., electronic or smart eyeglasses, and/o headwear (e.g., augmented reality (AR) or virtual reality (VR) headset), and bodywear (e.g., an electronic or smart watch, wearable sensor devices that information about the wearer (e.g. health-related information such as heart rate, blood pressure, blood sugar, oxygen levels, etc., information regarding mood and mental state, information regarding appetite, and information regarding the physical activity and behavior of the wearer (e.g., movement/motion data)). The UE 106 can also include various other types of mobile and fixed communication devices associated with users (e.g., owned, operated and/or otherwise registered to respective users), including but not limited to: a computer (e.g., a desktop computer, a laptop computer, laptop embedded equipment (LEE), laptop mounted equipment (LME), or other type of computer), a set-top box, an IP television (IPTV), a broadband communication device (e.g., a wireless, mobile, and/or residential broadband communication device, transceiver, gateway, and/or router), a dongle (e.g., a Universal Serial Bus (USB) dongle), a music or media player, speakers (e.g., powered speakers having wireless communication functionality), a home or building automation device (e.g., a security device, an access control device (e.g., smart locks), a climate control device, a lighting control device, or other type of home or building automation device), smart appliances (e.g., a toaster, a coffee maker, a refrigerator, or an oven, or other type of appliance having wireless communication functionality), a device associated or integrated with a vehicle (e.g., automobile, airplane, bus, train, or ship, or other type of vehicle), a virtual assistant (VA) device, a drone, an industrial or manufacturing related device, a farming or livestock ranch related device, and/or any other type of communication devices.

The term internet of things (IoT) device is used herein to any type of communication device with sensors, processing ability, software, and/or other technologies that collect and exchange data with other devices and systems over the Internet or other communications networks. The term “Internet of things” is an umbrella term that refers to the billions of physical objects or “things” connected to the Internet, all collecting and exchanging data with other devices and systems over the Internet. In this regard, the term “Internet of things” has been considered a misnomer because devices do not need to be connected to the public Internet, they only need to be connected to a network and be individually addressable. IoT devices are hardware devices, such as sensors, gadgets, appliances and other machines that can be programmed for certain applications and can communicate usable sensor data to users, businesses and other intended parties. Each IoT device has a unique identifier (UID) and can also transmit data without the assistance of humans. In this regard, IoT devices can be purely integrated with high-definition technology which makes it possible for them to communicate or interact over the via a network smoothly and can also be managed and controlled remotely.

IoT devices can range from small ordinary household cooking appliances to sophisticated industrial tools. For example, IoT can include consumer connected devices, such as smart home devices and wearable devices. In this regard, home security systems employing IoT devices are becoming increasingly popular. These home security system IoT devices employ sensors (e.g., cameras, acoustic sensors, motion sensors, thermal sensors, etc.) to capture information about the home environment and can be programmed to perform automated responses based on detection of certain conditions (e.g., automatically sounding an alarm, sending notification to connected devices/system, locking/opening doors, etc.). For example, home security cameras can be programmed to record at certain hours or when events such as motion or heat occur automatically. Connected home security cameras can save these recordings, stream recorded data to another system, or send alerts based on the recorded content. IoT home security devices can also allow users to arm and disarm their systems from anywhere with a smartphone app. Smart home devices can also complement home security systems with the ability to turn on lights, heat and air conditioning units, music, televisions, and more, to mimic household activities as if the person were home. IoT security devices are also being employed by industrial organizations (e.g., using IoT cameras, motion sensors, and automatic arm and disarm functions to maintain the security of their locations and job sites) and other public enterprises (e.g., local governments, cities, towns, etc.) to facilitate enhancing security operations associated with public environments. IoT devices can include environmental safety devices that employ sensors (e.g., chemicals sensors, thermal sensors, biological detectors) to detect information about the environment and facilitate performance of automated responses triggered by unsafe conditions like high temperatures or decreased oxygen. IoT devices can also include devices that monitor machine functioning.

In this regard, many of the UE 106 described above can be considered IoT devices. The IoT devices 108 of system 100 are distinguished from the UE 106 to specifically refer to IoT devices that can provide information about their environment captured via one or more sensors to the surveillance system 120 and/or that can perform a surveillance response controlled and/or facilitated by the surveillance system 120 (e.g., sounding an alarm, locking/unlocking access physical access points, disarming/arming a local machine or system etc.). The term security monitoring device as used herein refers to any IoT device comprising one or more sensors that can capture information about their environment or location, including information pertaining people, objects and conditions associated with their respective environment. The sensors can reside within the security monitoring devices or outside the devices and can communicate with other components in a wired or wireless fashion, depending on integration for respective embodiments. The sensors can comprise any suitable type of sensors (e.g., cameras, acoustic sensors, audio recording devices, motion sensors, activity sensors, positioning sensors, location tracking sensors, temperature sensors, thermal sensors, chemical sensors, pressure sensors, scanners, analog sensors, digital sensors, infrared sensors, ultrasonic sensors, accelerometers, gaze detection sensors, etc.) for collecting respective information regarding individuals, events, venues, activity, proximity, identity, context, environment, etc. The IoT devices 108 can include security monitoring devices distributed throughout the real-world environment, home security monitoring devices (e.g., associated with users' home environments), business security monitoring devices (e.g., associate with local businesses, stores, stadiums, airports and other public and/or private enterprises), and security monitoring devices distributed throughout indoor and outdoor public environments. In some embodiments, some UE 106 typically carried or worn by users (e.g., connected devices with audio/visual recording capabilities, such as smartphones, AR/VR devices, wearable health monitoring devices, wearable activity sensors, etc.) can be employed as security monitoring devices by the surveillance system 120.

In various embodiments, the surveillance system 120 can control one or more functionalities of the security monitoring devices, including data controlling data communication between the security monitoring devices and the surveillance system 120 via the communication network 110 (e.g., controlling one or more data communication scheduling parameters that control timing, rate, quality, etc. of communication of information between the security monitoring devices and the surveillance system 120 via the communication network 110). The surveillance system 120 can also remotely control programming of the respective devices (e.g., with respect to data capture timing, quality, type of data captured, reporting conditions, etc.), and in some embodiments remotely control positioning of the devices (e.g., location, orientation, perspective, etc. via mechanical actuators and/or machines coupled thereto and/or via directing users to capture audio/visual content via their UE at specific positions/locations relative to an environment). In some embodiments, the IoT devices 108 can include deployable security monitoring devices that are controllable by the surveillance system 120 via the communication network 110 (e.g., security monitoring device coupled to drones, vehicles and other mobile machines). The IoT devices 108 can also include electromechanical devices that can be remotely controlled by the surveillance system 120 in association with performing surveillance responses (e.g., physical access devices (e.g., locks), safety equipment, vehicles, alarms, a home or building automation device, an industrial or manufacturing related device, an implanted medical device (IMD), a farming or livestock ranch related device, etc.).

The communication network 110 can comprise but is not limited to, one or more wired and wireless networks, including, but not limited to, a cellular or mobile network, a wide area network (WAN) (e.g., the Internet), a local area network (LAN), and combinations thereof. Such networks can include Universal Mobile Telecommunications System (UMTS) networks, Long-Term Evolution (LTE) networks, Third Generation Partnership Project (3GPP) networks (or 3G), Fourth Generation (4G) networks, Fifth Generation (5G) networks, Sixth Generation (6G) networks (and beyond), Code Division Multiple Access (CDMA) networks, Wi-Fi networks, Worldwide Interoperability for Microwave Access (WiMAX) networks, General Packet Radio Service (GPRS) networks, Enhanced GPRS, Ultra Mobile Broadband (UMB), High Speed Packet Access (HSPA), Evolved High Speed Packet Access (HSPA+) networks, High-Speed Downlink Packet Access (HSDPA) networks, High-Speed Uplink Packet Access (HSUPA) networks, Zigbee networks, or another IEEE 802.XX technology networks. Additionally, substantially all aspects disclosed herein can be exploited in legacy telecommunication technologies. Further, the various aspects can be utilized with any Radio Access Technology (RAT) or multi-RAT system where the mobile device operates using multiple carriers (e.g., LTE Frequency Division Duplexing (FDD)/Time-Division Duplexing (TDD), Wideband Code Division Multiplexing Access (WCMDA)/HSPA, Global System for Mobile Communications (GSM)/GSM EDGE Radio Access Network (GERAN), Wi Fi, Wireless Local Area Network (WLAN), WiMax, CDMA2000, and so on), and satellite networks.

In this regard, the communication network 110 can be associated with a single network provider, multiple network providers, and/or encompass a variety of different type of wired and wireless communication technologies (e.g., 3GGP, WiFi, LTE, satellite, 5G, etc.) and sub-networks. The communication network provider systems 116 can comprise computing systems that are owned/operated and/or controlled by the one or more communication network providers. For example, in some implementations, the one or more communication network provider may correspond to a telecommunications service provider/carrier that provides a wide range of different types of telecommunication services to different types of communication devices via one or more communication networks (e.g., communication network 110) and sub-networks comprised of network equipment/resources owned/operated by the telecommunication service provider. The types of services can vary depending on the network capabilities and communication technologies supported by the communication network (e.g., cellular 3G, 4G, 5G, Wi-Fi, satellite, etc.) and the features and functionalities of the respective communication devices. For example, as applied to advanced communication network providers providing New Radio/5G communication networks and beyond, the types services can relate to, for example, video streaming, video calls, video content, audio streaming, audio calls, audio content, electronic gaming, education, text messaging, multimedia messaging, emails, website content, medical information (e.g., medical information from wireless medical devices associated with users), utility information (e.g., utility information from smart meters), emergency-related information, military-related information, law enforcement-related information, fire response services-related information, disaster response services-related information, and/or other desired types of information, content, or activities. As applied to the disclosed subject matter, the communication services can also include the various surveillance services performed and/or facilitated by the surveillance system 120.

With these embodiments, the communication network provider can control provision of communication services to respective communication devices via the communication network 110 in accordance with established communication service agreements (e.g., customer/user subscription agreements/plans) associated with the respective communications devices and their users. For example, the communication service provider can maintain customer/subscriber account information for all subscribed users that uniquely identifies each subscriber of the network (e.g., via username/account information) and uniquely identifies their associated communication device or devices (e.g., via unique device identifiers) authorized to employ the communication network 110 (e.g., including UE 106 and IoT devices 108). In accordance with system 100, the communication network service provider systems 116 can include one or more systems and/or databases that maintain or otherwise provides access to such subscriber information for the communication service provider. The communication service provider can also maintain additional information regarding respective communication devices subscribed to or otherwise connected to the communication network 110, including but not limited to, device location information (e.g., including fixed location devices and mobile device locations) and device capability information.

In some embodiments, the non-limiting term network equipment (NE), network device, and network node are used herein. These terms may be used interchangeably and refer to any type of physical resource (e.g., devices, computers, processors, switches, cables, data storage devices, routers, etc., including virtualized devices, computers, processors, switches, cables, data storage devices, routers) of the communication network 110, which can vary depending on the type or types of wired and wireless communication technologies (e.g., 3G, 4G, LTE, 5G, WiFi, satellite, etc.) employed by the communication network 110. In this regard, the NE 104 can include or be associated with physical and logical (i.e., software defined) network components or resources of the communication network 110 that provide essentially any network provider controlled function of the communication network 110, including network access related functions, data transport related functions, and network core processing functions.

For example, in various embodiments, the communication network 110 can comprise a distributed network architecture including a plurality of different network resources (i.e., NE 104) distributed between an access network layer, a transport layer and a network core layer. These network resources can include physical resources (e.g., devices, hardware, etc.) as well as logical resources (e.g., radio frequency spectrum resources, data processing resources, etc.). The access network layer controls connection and access of communication devices and systems (e.g., UE 106, IoT devices 108, virtual world system 112, other systems 112, one or more communication network provider systems 116) to the communication network 110 via one or more physical network access points (APs) located in the real-world environment 102. The network access layer usually incorporates Layer 2 switches and access point devices that provide connectivity between workstations and servers. In this regard, the NE 104 can include physical access point (AP) devices, system, and/or sub-networks that control physical connectivity of communication devices to the communication network 110. The logical network resources associated with the access layer can include a variety of different software defined tools that control logical access to the network, such as tools for managing access control with respect to network policies and security (e.g., credentials, validation, authorization, etc.). These components can enforce access control measures for systems, applications, processes and information. For example, the logical network resources associated with the access layer can manage access control and policy, create separate collision domains, and implement port security.

The types of the physical APs can vary and can include a variety of different types of access points devices/systems that employ a variety of different types of wired and wireless communication access technologies (e.g., 3G, 4G, LTE, 5G, WiFi, satellite, etc.) employed by the communication network 110. Depending on the type of the APs, the APs may be standalone AP devices or part of separate communication networks (e.g., satellite communication networks, mobile communication networks, cellular communication networks, multi-carrier communication networks, etc.). For example, in various embodiments, the communication network 110 can include a cellular communication network that employs a RAN architecture. The cellular communication network can correspond to a 5G network, an LTE network, a 3G network or another type of cellular technology communication network. The RAN can comprise various network components or devices, which can include one or more RANs, wherein each RAN can comprise or be associated with a set of base stations located in respective coverage areas served by the respective base stations. The respective base stations can be associated with one or more sectors (not shown), wherein respective sectors can comprise respective cells. The cells can have respective coverage areas that can form the coverage area covered by the one or more sectors. Communication devices can be communicatively connected to the cellular communication network via respective wireless communication connections with one or more of the base stations. In this regard, examples of NE 104 corresponding to radio network nodes are Node B, base station (BS), multi-standard radio (MSR) node such as MSR BS, gNodeB, eNode B, access point (AP) devices, network controller, radio network controller (RNC), base station controller (BSC), relay, donor node controlling relay, base transceiver station (BTS), transmission points, transmission nodes, radio resource unit (RRU), remote radio head (RRH), nodes in distributed antenna system (DAS), etc.

In some embodiments, the one or more RANs can be based on open-RAN (O-RAN) technology and standards. These standards can define the open interface that can support interoperability of network elements (e.g., radio unit (RU), central unit (CU), distributed unit (DU), real or near real time RAN intelligent controller (RIC), or other types of network elements from different entities (e.g., vendors). The network elements may be virtualized, e.g., software-based components that can run on a common virtualization/cloud platform. In certain embodiments, the O-RAN based RAN can utilize a common platform that can reduce reliance on proprietary platforms of service providers. The O-RAN based RAN also can employ standardized interfaces and application programming interfaces (APIs) to facilitate open source implementation of the O-RAN based RAN.

In some embodiments, the one or more RANs can be a cloud-based radio access network (C-RAN). A C-RAN is a deployment paradigm that seeks to isolate baseband unit (BBU) from its remote radio unit (RRU) in base station (BS), consolidating the BBUs into a common place referred to as the BBU pool. In the BBU pool, the computing resources provided by the BBUs can be dynamically assigned to RRUs on demand by the BBU controller. Thus, with the fluctuation of data traffic from RRUs, a part of BBUs can be dynamically turned on or off.

The network transport layer serves as the communication point between the access layer and the network core where the communication network provider systems 116 typically reside. Its primary functions are to provide routing, filtering, and quality of service (QoS) management and to determine how packets can access the core. For example, the NE 104 can also include physical network resources associated with the transport layer, which usually consists of routers, routing systems, and multilayer switches. Logical network resources associated with the transport layer can include computer-executable components that can determine and control the most efficient way that network service requests are accessed—for example, how a file request is forwarded to a server—and, if necessary, forwards the request to one or more network resources associated with the network core layer.

The core layer of the communication network 110, also referred to as the network backbone, is responsible for transporting large amounts of traffic quickly. The core layer provides interconnectivity between the transport layer devices. The physical and logical network resources associated with the core layer can vary depending on the architecture of the communication network. Next generation or 5G cellular networks are implementing substantially software defined network core elements. The network core typically provides key Evolved Packet Core functions including the Mobile Management Entity (MME), the Serving Gateway (S-GW), the Packet Data Network Gateway (PDN-GW), the Home Subscriber Server (HSS), a Policy Control Rules Function (PCRF), an Access and Mobility Management Function (AMF), a User Plane Function (UPF), and others. The network core layer may include high speed NE devices, like high end routers and switches with redundant links.

In accordance with various embodiments, the communication network provider systems 116 can correspond to network systems associated with the network core layer of the communication network 110 (however other configurations are envisioned). Respective systems (and/or components thereof) of the communication network provider system 116 (e.g., the resource management system 118, the surveillance system 120, and various additional systems) can be communicatively and/or operatively coupled via any suitable wired or wireless communication technology. In some embodiments, the resource management system 118 can control the allocation and distribution of resources of the communication network 110 in association with performing communication services provisioned by the communication network 110. These communication services can include various surveillance services provided by and/or facilitated by the surveillance system 120, as discussed below.

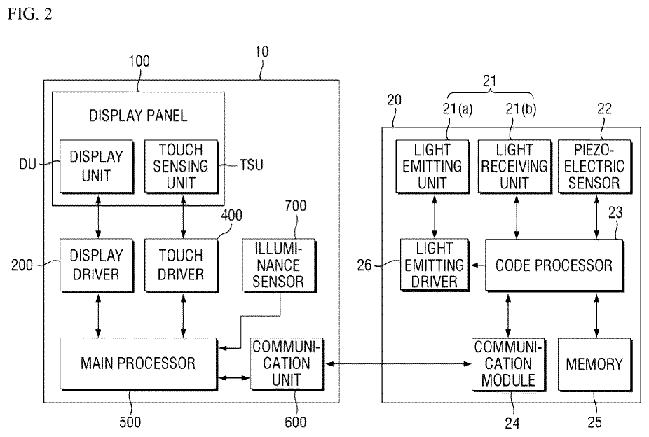

FIG. 2. illustrates a block diagram of the surveillance system 120 in accordance with one or more embodiments of the disclosed subject matter. The surveillance system 120 includes machine-executable components 202, storage 218, communication component 230, processing unit 216 and memory 232. The surveillance system 234 further includes a system bus 234 that couples the machine-executable components 202, the storage 218 the communication component 230, the processing unit 216 and the memory 232 to one another. In some embodiments, machine-executable components 202 can be stored in memory 232 and executed by the processing unit 216 to cause the computing system 100 to perform operations described with respect to the corresponding components. In this regard, the surveillance system 120 can correspond to any suitable computing system, device or machine (e.g., a communication device, a server device, a desktop computer, a personal computer, a smartphone, a virtual computing device, a processor, etc.), or interconnected group of computing systems, devices, and/or machine (e.g., interconnected via wired and/or wireless communication technologies).

In some embodiments, memory 232 can comprise volatile memory (e.g., random access memory (RAM), static RAM (SRAM), dynamic RAM (DRAM), etc.) that can employ one or more memory architectures. Further examples of memory are described below with reference to system memory 804 of FIG. 8 discussed below. In some embodiments, storage 218 can comprise non-volatile memory (e.g., read only memory (ROM), programmable ROM (PROM), electrically programmable ROM (EPROM), electrically erasable programmable ROM (EEPROM), etc.) that can employ one or more storage architectures. Such examples of memory 232 and storage 218 can be employed to implement any embodiments of the subject disclosure described or suggested by disclosures herein.

According to multiple embodiments, the processing unit 216 can comprise one or more processors and/or electronic circuitry that can implement one or more computer and/or machine readable, writable, and/or executable components and/or instructions that can be stored using memory 232 and storage 218. For example, the processing unit 216 can perform various operations that can be specified by such computer and/or machine readable, writable, and/or executable components and/or instructions including, but not limited to, logic, control, input/output (I/O), arithmetic, and/or the like. In some embodiments, processing unit 216 can comprise one or more central processing unit, multi-core processor, microprocessor, dual microprocessors, microcontroller, System on a Chip (SOC), array processor, vector processor, and/or another type of processor. Further examples of the processing unit 216 are described below with reference to processing unit 804 of FIG. 8 below. Such examples of the processing unit 904 can be employed to implement any embodiments of the subject disclosure.

The storage 218 can store a variety of information that is received by, used by, and/or generated by the surveillance system 120 in association with identifying and minimizing social and virtual incidents in accordance with various aspects and embodiments of the disclosed subject matter. In the embodiment, shown, this information includes (but is not limited to), incident assessment data 220, surveillance protocol assessment data 222, user profile data 224, logged user activity data 226 and logged incident data 228. The surveillance system 120 can also be communicatively coupled (e.g., via wired and/or wireless communication technologies) to various external databases and/or systems (e.g., one or more other systems 114) that can provide information that can be used by the surveillance system 120 in association with identifying and minimizing social and virtual incidents in accordance with various aspects and embodiments of the disclosed subject matter. In the embodiment shown, these databases include incident domain knowledge datastore 107 and network datastore 109. The incident domain knowledge datastore 107 and the network datastore 109 can correspond to any suitable machine-readable media that can be accessed by the surveillance system 120 and includes both volatile and non-volatile media, removable and non-removable media implemented in any method or technology for storage of information, such as computer-readable instructions, data structures, models, algorithms, program modules, or other data. Computer storage media can include, but is not limited to, random access memory (RAM), read only memory (ROM), erasable programmable read only memory (EPROM), flash memory or other memory technology, digital video disk (DVD) or other optical disk storage, magnetic cassettes, magnetic tape, magnetic disk storage or other magnetic storage devices, or any other medium which can be used to store the desired information and which can be accessed by the surveillance system 120.

The communication component 230 can correspond to any suitable communication technology hardware and/or software that can perform wired and/or wireless communication of data between the surveillance system 120 and other systems, devices and/or data storage media. In this regard, the communication component 230 can provide for receiving input data 105 from one or more external systems and/or devices and communicating (e.g., sending, transmitting, etc.) output data 119 to one or more external systems and/or devices. The communication component 230 can also provide for accessing information/data located at one or more external devices, systems and/or storage media (e.g., provided in the incident domain knowledge datastore 107, the network datastore 109, and any of the systems and devices connected to the communication network 110 of system 100). Examples of suitable communication technology hardware and/or software employable by the communication component 230 are described infra with reference to FIG. 8.

The machine-executable components 202 can include monitoring component 204, logging component 206, incident assessment component 208, surveillance protocol assessment component 212 and artificial intelligence component 214.

With reference to FIGS. 1 and 2, the monitoring component 204 can receive and monitor information (i.e., user activity/context data 101 and incident report data 103) regarding activities of users relative to respective environments or locations in the real-world environment 102 and/or a virtual environment (e.g., provided by the virtual world system 112). In various embodiments, some or all of the input data 105 received by the surveillance system 120 can be logged and time-stamped (e.g., as it is received) by the logging component 206 (e.g., as logged user activity data 226). The logged user activity/context data 101 and the incident report data 103 can be indexed by respective users (e.g., via user identifiers, equipment identifies for the respective users, account identifies for the respective users, etc.) to which the data is associated and/or respective locations or environments with which the data is associated.

The user activity/context data 101 can include any information that identifies or indicates respective current or forecasted locations, behaviors, activities, health status (e.g., physical and/or mental health status) identities, and/or appearances of users (i.e., people) in the real-world environment 102 and/or the virtual environment. The user activity/context data 101 can also include any information related to current and forecasted user contexts relative to respective environments and current and forecasted environmental conditions. In this regard, the user activity/context data 101 can essentially include any information that identifies or indicates where people are located, where there are going, what they are doing, and the context associated with their activity.

In one or more embodiments, the user activity/context data 101 can include any information provided to the surveillance system 120 via one or more security monitoring devices (e.g., one or more IoT devices 108) deployed in the real-world environment 102 that identifies or indicates respective behaviors, activities and/or appearances of users (i.e., people) in the real-world environment. For example, the user activity/context data 101 can include image data (e.g., still images, video, etc.) captured via cameras distributed at various locations throughout the real-world environment 102 (e.g., home security cameras, business/enterprise security cameras, cameras distributed in public and/or private outdoor environments (e.g., streets, parks, and other outdoor environments). The image data can be coupled with audio in implementations in which the cameras are configured to capture and record audio. The user activity/context data 101 can also include audio data alone captured via one or more acoustic sensors and/or audio recording/capture devices. The user activity/context data 101 can also include various other sensory data captured via one or more sensors relating to behavior/activities of users and/or conditions of the respective monitored environments (e.g., motion sensors, activity sensors, positioning sensors, location tracking sensors, temperature sensors, thermal sensors, chemical sensors, pressure sensors, scanners, analog sensors, digital sensors, infrared sensors, ultrasonic sensors, accelerometers, gaze detection sensors, etc.).

The security monitoring devices can be configured to provide the corresponding user activity/context data 101 (e.g., image data, audio data, motion data, and other sensor captured data) to the surveillance system 120 in a continuous, real-time manner (e.g., live streaming of capture data), according to a defined schedule (e.g., which can be programmed and/or controlled by the surveillance system 120), in response to triggering events or conditions (e.g., based on detection of certain activity and/or conditions represented in the captured data and/or a condition related to the captured data, such as sending captured audio/visual data in response to detection of motion/user activity, detection of certain trigger sounds, and so on, which can also be programmed and/or controlled by the surveillance system 120). The security monitoring devices can also be configured to provide the corresponding user activity/context data 101 to the surveillance system 120 in response to reception of instructions or requests from the surveillance system 120 requesting provision thereof in accordance with the instructions provided by the surveillance system 120. In this regard, in some embodiments, the surveillance system 120 can remotely control activation of one or more of the security monitoring devices and various other functionalities of the security monitoring devices (e.g., via the surveillance protocol execution component) that control data capture (e.g., with respect to type of data, quality of data, timing of capture, position of capture, etc.) and provision of the capture data to the surveillance system 120 via the communication network 110.

The surveillance system 120 can further process (e.g., using incident assessment component 208) the sensory data (e.g., image data, audio data, motion data, and other sensory data) received from the security monitoring devices using corresponding automated data processing technologies that can interpret the sensory data and correlate the sensory data to defined human behaviors, activities, attributes and environmental conditions (e.g., using object detection/recognition technologies, facial recognition technologies, motion recognition technologies, gesture recognition technologies, voice to text translation technologies, and so on). For example, video data capture of a person or group of people in the real-world environment 102 can be analyzed using 2D and/or 3D image analysis to and pattern recognition to correlate physical movements of the person and/or people to defined physical behaviors and/or actions and activities, combined with object recognition to identify and characterize objects and other entities (e.g., other people, buildings, etc.) in the environment. Facial recognition technologies can also be employed to determine or infer identities of users and attributes related to the persons facial expressions and mood. Image data captured of people can also be processed using pattern recognition technologies to characterize appearance and demographic attributes of people (e.g., gender, age, height, weight, hair color, eye color, clothing worn, accessories worn, objects held, etc.). Audio recordings captured in an environment can also be processed using automated audio recognition and interpretation technologies to determine words spoken (e.g., using voice-to-text and natural language processing (NLP)), and other attributes (e.g., tone of voice, volume, pace, slurring of words, etc.). Audio recordings comprising a totality of sounds from an environment can also be processed using automated audio recognition to characterize the context of the environment (e.g., number of people in the environment, type of activity occurring in the environment, etc.).

In various embodiments, the respective security monitoring devices can be associated with IUDs and location information that identifies their respective locations (e.g., fixed or mobile) where their corresponding data was captured. In some embodiments, identifying the security monitoring devices (e.g., via IUDs), their locations, their capabilities, and their current operating configurations, and/or their current operating status (e.g., with respect to activation, data capture, power level, position/orientation, etc.) can be maintained by the provider/carrier of the communication network 110 (e.g., included with device status data 115) in the network datastore 109. For example, the device status data 115 can include a variety of relevant information about all communication devices connected to and/or subscribed to the communication network 110 (e.g., NE 104, UE 106 and IoT devices 108), including unique identifies for the respective communication devices and information regarding their locations, capabilities, and their current operating configurations and/or status. The network datastore 109 can correspond to one or more datastores associated with the communication network provider systems 116. The network datastore 109 can also include network resource data 111 comprising information identifying physical and logical resources of the communication network 110 and current allocations of the respective resources allocated by the communication network 110 (e.g., by the resource management system 118) in association with provisioning communication services to respective communication devices connected to the communication network 110. The network datastore 109 can also include device scheduling information 113 that identifies current scheduling parameters used to communicate data between communication devices and NE 104 (e.g., base stations, routers, etc.) of the communication network 110 (i.e., wireless connection uplink/downlink parameters, transmission quality parameters, transmission rate parameters, reliability parameters, etc.).

The current user activity/context data 101 can also include information regarding the current locations, mobility states and movement patterns of respective UE 106 associated with individuals or users in the real-world environment. In this regard, the monitoring component 204 can monitor and track the locations, mobility states and movement patterns of users in the real-world environment 102 in real-time (or substantially real-time) via tracking corresponding information provided by UE 106 carried by, worn by, or otherwise associated with (e.g., in-vehicle devices) the respective users (e.g., using any suitable device location tracking, mobility state tracking and/or movement tracking technologies).

The user activity/context data 101 can also include any information related to user activity, behaviors, gestures, movement, and/or health status provided to the surveillance system 120 via wearable devices associated with users (e.g., activity tracking devices, health monitoring devices, etc.). Such wearable devices can be configured to provide the corresponding user activity/context data 101 to the surveillance system 120 in a continuous, real-time manner (e.g., live streaming of capture data), according to a defined schedule (e.g., which can be programmed and/or controlled by the surveillance system 120), in response to triggering events or conditions (e.g., based on detection of certain activity and/or conditions represented in the captured data and/or a condition related to the captured data, which can also be programmed and/or controlled by the surveillance system 120). The security monitoring devices can also be configured to provide the corresponding user activity/context data 101 to the surveillance system 120 in response to reception of instructions or requests from the surveillance system 120 requesting provision thereof in accordance with the instructions provided by the surveillance system 120.

For example, the wearable devices can provide include health monitoring device that provide information about the wearer's current physiological state and/or mental state (e.g., heart rate, body temperature, respiration, perspiration, blood pressure, calories burned, body fat, and body weight, glucose levels, cortisol levels, blood alcohol levels, presence of drug residues, presence of pathogens, presence of bacteria, mood, energy level, fatigue level, etc.). The wearable devices can also provide user activity/context information 101 related to the user's physical movement patterns, gestures, behaviors and physical activities based on data capture via wearable movement/motion sensors including fine-tuned accelerometers and gyroscopes combined with pattern. For example, the wearable devices can capture motion identifying acceleration, rotation/orientation, and/or velocity of the wearable device itself, facilitating determination of motion and movement data of the body and/or body parts to which the motion sensors are attached. The raw motion data can further be processed (e.g., by the capture device and/or another system (e.g., the surveillance system 120) using pattern analysis to determine or infer types of motion represented by the motion data and/or characteristics associated with the types of motion (e.g., intensity, duration, range, speed, etc.). For example, using pattern recognition, patterns in the motion data can be correlated to know patterns for different types of motion, such as sitting, standing, laying, walking, running, climbing, jumping, falling, cycling, turning, sleeping, number of steps, to even minute bodily motions such as strokes of a finger or the blinking of an eye and gestures. Motions sensors such as accelerometers can also be used in detection for Parkinson's disease. Patients of Parkinson's disease are known to have involuntary shaking. For those having mild symptom, shaking might not be significant. Since an accelerometer is sensitive enough to detect even mild shaking, when it is placed on a patient's arm while he/she is intended to hold the arm in still, the accelerometer could report involuntary shaking.

As applied to monitoring user activity in virtual environments, the user activity/context data 110 can include any information describing or indicating the behaviors and/or activities of users as represented via their avatars in respective VR environments. Such information can include information identifying respective locations of avatars corresponding to real user identities in the VR environments, physical actions or behaviors performed by the avatars, appearances of the avatars (e.g., clothing, attire, accessories, etc.), words and sounds expressed by the avatars (e.g., including content spoken or typed), and other digital content (e.g., digital images, media, multimedia, etc.) whose rendering in the VR environments is controlled by the avatar/user.

The user input data 105 can also include incident report data 103 corresponding to incident reports provided by users regarding incidents or potential incidents detected in the real-world environment 102 and/or a virtual environment. In this regard, the surveillance system 120 can employ a user reporting incident mechanism to identify or facilitate identifying incidents via which users can submit incident reports regarding incidents or potential incidents observed in their environments via their connected user equipment (e.g., smartphones, smart watches, wearable devices, personal computers, etc.). For example, via their respective UE 106, users can submit incident reports to the surveillance comprising information (e.g., text, image data, audio data, etc.) identifying or indicating an incident or potential incent, the location or environment of the incident or potential incident, the person or persons involved in the incident, and any other relevant information describing the incident and the context of the incident. The surveillance system 120 can provide rewards or incentives to user for submitting incident reports, such as discounts on subscription services provided by the communication network 110, discounts on user equipment hardware and/or software upgrades, and the like.

In some embodiments, the monitoring component 204 can be configured to monitor the input data 105 as it is received in real-time in association with detecting defined events or conditions in the input data 105 that satisfy one or more defined incident risk criteria (e.g., defined in the incident assessment data 220) that amount to an incident or a potential incident. For example, the incident risk criteria can relate to one or more behaviors, activities and/or appearances of any user (or avatar) considered to be non-conforming or potentially non-conforming to acceptable user behaviors, activities and/or appearances for a particular location or environment. The incident risk criteria can also relate to one or more behaviors, activities and/or appearances of specific users or user profiles (or avatars) considered to be non-conforming or potentially non-conforming to acceptable user behavior or activity for a particular location or environment (e.g., based on user age, gender and other demographics, based on user history, based on user roles relative to a location/environment, based on user permission relative to a location/environment, etc.), including detected presence of specific users or user profiles in locations or environments in which they are unauthorized. The incident risk criteria can also relate to detected presence of specific users or any user at or near an incident location. The incident risk criteria can also relate to one or more health status factors considered to be non-conforming or potentially non-conforming to acceptable or safe health states for a particular location or environment and/or individual. The incident risk criteria can also relate to human behavior or activity that may be considered to impose a risk of injury or harm to oneself or others, including physical and/or mental injury to individuals and/or property.

In this regard, the term “incident” as used herein can refer to any type of human behavior or activity in the real-world or a virtual world (i.e., the Metaverse™ and the like) that could be considered non-conforming to a social or societal construct of the corresponding environment, such as behavior or activity that violates societal rules and/or norms, from criminal activity to dressing, speaking or otherwise behaving in a manner considered inappropriate for the environment and/or context. In other words, an incident can include any type of human behavior that “breaks the rules,” wherein the rules can be predefined and vary based on the environment and context. For instance, an incident or potential incident could involve a person or group of people (e.g., two more) behaving inappropriately towards another person, wherein what constitutes “inappropriate,” can be predefined based on the environment and context. Incidents associated with a virtual world can be based on the behavior or activity of users as expressed via their representative avatars. An incident can also refer to any human behavior or activity that may be considered to impose a risk of injury or harm to oneself or others, including physical and/or mental injury to individuals and/or property.

In this regard, the surveillance system 120 can be configured to detect and respond to a wide range of different types of incidents associated with different environments and contexts, including incidents corresponding to criminal activity, non-criminal activity that violates any predefined rules for an environment and context (e.g., dressing inappropriately, speaking inappropriately, etc.) and/or behavior or activity determined to impose a risk to oneself or others. Some incidents or potential incidents may be automatically identified and detected by the monitoring component 204 based on events or conditions in the input data 105 that satisfy one or more defined incident risk criteria (e.g., defined in the incident assessment data 220) that amount to an incident or a potential incident without further analysis of the input data 105 and/or additional information related to the incident. For example, some incidents can be detected based on reception of user location data (e.g., corresponding to the location of their UE 106 as included in the user activity/context data 101) indicating a particular user is located at or near an unauthorized location. In another example, the monitoring component 204 can be configured to automatically identify incidents based on information included in received incident report data 103 satisfying one or more defined incident risk criteria. In some embodiments, the incident risk criteria can also relate to the number of received incident reports corroborating a same incident. In another example, the monitoring component 204 can be configured to identify potential incidents associated with a location based on the user activity/context data 101 indicating any type of user activity and/or motion at a location. In another example, the monitoring component 204 can be configured to identify incidents or potential incidents based on a user health parameter received in the user activity/context data 101 satisfying an incident risk criterion (e.g., heart rate exceeding a threshold, blood pressure, temperature too high, etc.).

However, the detection, identification and characterization of many incidents can require a deeper analysis of the input data 105 and a multitude of factors related to the incent and the environment. For example, in some embodiments, the surveillance system 120 may need to process (e.g., using incident assessment component 208) sensory data (e.g., image data, audio data, motion data, and other sensory data) received from the security monitoring devices using corresponding automated data processing technologies to interpret the sensory data and correlate the sensory data to defined human behaviors, activities, attributes and environmental conditions (e.g., using object detection/recognition technologies, facial recognition technologies, motion recognition technologies, gesture recognition technologies, voice to text translation technologies, and so on). Likewise, the surveillance system 120 may need to process (e.g., using incident assessment component 208) user health data and/or activity data received from wearable devices to correlate the data to health states, mental states, and/or user behaviors, activities, gestures, motions, and so on. The detection, identification and characterization of many incidents can further involve analysis a multitude of different factors related to the location of the incident or potential incident, the context of the incident or potential incident, the individual or individuals involved (e.g., identities, known profiles and history of the individual/individuals, number of individuals, user demographics, etc.), the probability of escalation or occurrence of the incident, the amount and validity of received incident reports about the incident, and known and forecasted risk associated with the incident (among others). This evaluation and characterization of respective incidents can incorporate predefined rules, algorithms and/or models, including ML and AI algorithms/models (e.g., trained and developed by the artificial intelligence component 214).

In this regard, in some embodiments, the monitoring component 204 can be configured to monitor the input data 105 as it is received in real-time in association with detecting defined events or conditions in the input data 105 that satisfy one or more defined incident risk criteria (e.g., defined in the incident assessment data 220) that amount to an incident or a potential incident. In various embodiments, the monitoring component 204 can characterize incidents or potential incidents based on the location associated with the incident. As used herein, an incident location refers to a specific location or environment (e.g., area) in the real-world and/or virtual word associated with occurrence or potential occurrence of an incident. An incident location can correspond to a current location or environment where an incident is occurring or potentially occurring in real-time (i.e., the current location of the person or group of people performing an activity or behavior that corresponds to an incident or a potential incident). The monitoring component 204 can determine a real-world location associated with a current incident based on the location of the device or devices from which user activity/context data 101 for which an incident is based is received, based on the location information being included in the incident report data 103, and/or based on the location of a device associated with the offending person or persons (e.g., user equipment worn or carried by the offending person) and using various known location detection/tracking means (e.g., global positioning system (GPS) means, indoor positioning system technology, etc.). Information regarding a virtual world incident location can relate to a virtual room or environment included in the virtual world and/or a real-world location of the user device employed to access the virtual room or environment.

The monitoring component 204 can further be configured to initiate further assessment of an incident or potential incident associated with an incent location by the incident assessment component 208 to facilitate identifying and characterizing an incident or potential incident and responding to an incident or potential incident. In this regard, the monitoring component 204 can monitor the input data 105 in association with detecting triggering events or conditions represented in the input data 105 that indicate an incident or potential incident. Information defining the triggering events or conditions can be defined in the incident assessment data 220 and vary for different locations, contexts and applications.

In some implementations, a triggering event or condition can include reception of one or more incident reports. For example, the monitoring component 204 can be configured to activate assessment of an incident or potential incident by the incident assessment component 208 in response to reception of a single incident report associated with a location and/or reception of a defined number of corporation reports for the location. In another example, a triggering event or condition can include reception of any user/activity context data 101 associated with a particular location, reception of a specific type of user activity/context data 101 associated with a particular location, and/or an amount or frequency of user activity/context data 101 received for a particular location. For example, in some embodiments, the surveillance system 120 can characterize some locations as historical incident locations based on known associations of the locations with incidents or a high risk of incidents in the past. For instance, certain environments may be known to have a higher rate or risk/rate of incidents based on known risks associated with the locations (e.g., attributed to the natural landscape, weather, activities performed at the locations, etc.) historical user activity at the locations, such as certain neighborhoods, buildings, event locations, crowded areas (e.g., airports, stadiums), certain natural environments (e.g., dangerous hiking trails, rapid waters, etc.) and so on. In some implementations of these embodiments, a triggering event or condition can include reception of any input data 105 and/or reception of specific events or conditions in the input data for a historical incident location. Information identifying and describing historical incident locations can be included in the incident assessment data 220. The surveillance system 120 can employ AI and ML techniques (e.g., performed by the artificial intelligence component 214) to facilitate identifying, classifying and characterizing historical incident locations based on analysis of the logged user activity data 226, logged incident data 228 and additional information regarding incidents associated with the locations provided by various sources (e.g., aggregated in the incident domain knowledge datastore 107).

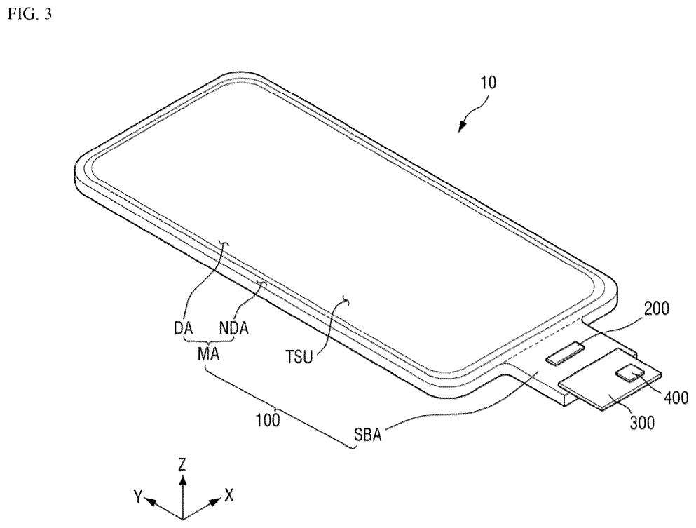

Based on detection of an incent or potential incident associated with a location by the monitoring component 204 in accordance with the triggering events or conditions defined for respective incidents and/or incent locations, the incident assessment component 208 and the monitoring component 204 can work together to actively monitor and assess the incident or potential incident. In particular, the incident assessment component 204 can determine or infer whether an incident is occurring or likely to occur, the type of the incident, what the incident entails, who is involved, a level of severity of the incident, risks associated with the incident, the context of the incident, and so on, to facilitate determining an optimal game plan for responding to the incident. To facilitate this end, the incident assessment component 208 can analyze the relevant input data 105 associated with the incident location along with additional information related to the incident location and the individual or individual involved included in user profile data 224, logged user activity data 226 associated with the incident location and/or the incident type, logged incident data 228 associated with the incident location and/or the incident type, and incident domain knowledge (e.g., included in the incident domain knowledge datastore 107). This evaluation and characterization of respective incidents can incorporate predefined rules, algorithms and/or models, including ML and AI algorithms/models included in incident assessment data 220. Based on determination that an incident is occurring or potentially occurring at a location, the incident assessment component 208 can continue to assess and characterize the incident based on continued relevant input data 105 monitored and received for the incident until the incident assessment component 208 determines that the incident has been remediated or has otherwise ended. The incident assessment component 208 can further generate and log (e.g., as logged incident data 228) incent reports for potential incidents and actual incidents. Additional details regarding the incident assessment component 208 are discussed infra with reference to FIG. 3.

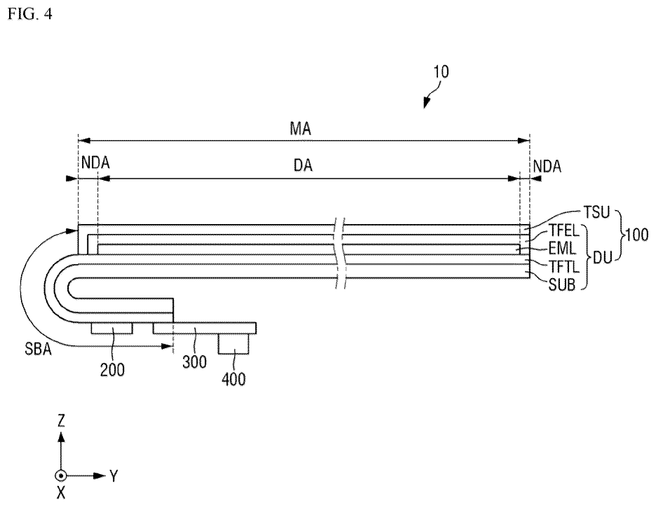

The surveillance protocol assessment component 210 can further determine how to respond to detected incidents or potential incident in an optimal manner. In various embodiments, the surveillance protocol assessment component 210 can determine targeted surveillance protocols related to monitoring incident locations and corresponding incidents associated with the locations and performing actions that facilitate minimizing occurrence of the corresponding incidents based on the incident types, severities and/or various other factors related to the incident location and context. To facilitate this end, the surveillance protocol assessment component 210 can employ predefined surveillance protocol assessment data 222, ML and AI to determine the or facilitate determining the targeted surveillance protocols based on relevant information about the respective incidents, including the incident type, severity, the location, context of the individual, the individual or individuals involved (e.g., identities, known profiles and history of the individual/individuals, number of individuals, user demographics, etc.), the probability of escalation or occurrence of the incident, the amount and validity of received incident reports about the incident, and known and forecasted risks associated with the incident. In this regard, the targeted surveillance protocols can be tailored to the context and surveillance service needs associated with the respective incidents as the incidents arise and can be dynamically adapted to account for changes in the escalation and/or de-escalation of the incidents as they are progressively monitored. The targeted surveillance protocols can involve utilizing various surveillance services performed by and/or facilitated by the surveillance system 120 and/or the communication network 110. The surveillance services can include essentially any task or function performed or facilitated by the surveillance system and/or the communication network related to monitoring user activity at incident locations, identifying and characterizing incidents, determining optimal responses to the incidents, and performing or facilitating performing the responses. Additional details regarding the surveillance protocol assessment component 210 are discussed infra with reference to FIG. 4.

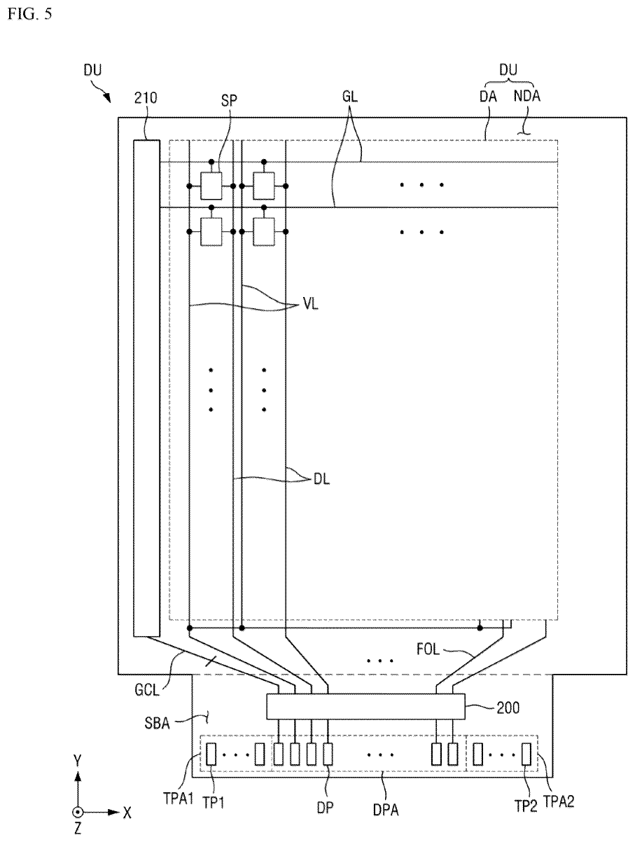

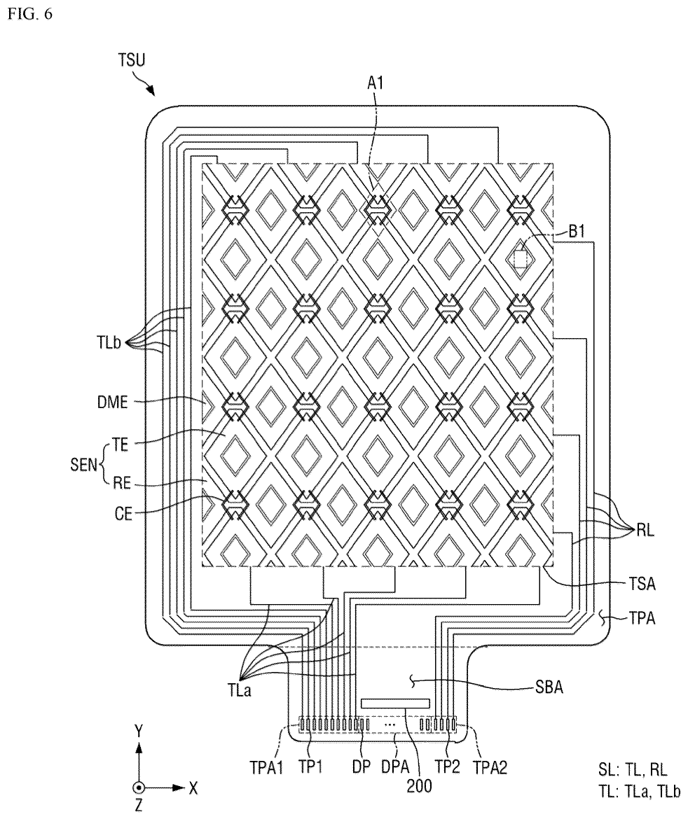

The surveillance protocol execution component 212 can further execute and/or control execution or implementation of the targeted surveillance protocols. In this regard, depending on the actions and/or tasks associated with the targeted surveillance protocols, this can involve communicating instructions, notifications, and/or machine controls signals to NE 104, UE 106, IoT devices 108, one or more communication network provider systems 116 (other than the surveillance system 120), the virtual world system 112, and/or one or more other systems 114. Such instructions, notifications, and/or machine controls signals can be considered output data 119 of the surveillance system 120 and are collectively referred to as surveillance protocol response data 117. Additional details regarding the surveillance protocol execution component 212 are discussed infra with reference to FIG. 5.

FIG. 3 presents an example incident assessment component 208 in accordance with one or more embodiments of the disclosed subject matter. The incident assessment component 208 can include various machine-executable components, including analysis component 302, activity/context analysis component 304, report analysis component 306, severity analysis component 308, incident identification component 310, incident ranking component 310, incident tracking component 312, credibility rating component 314, incident report component 316, and reward component 318.

With reference to FIGS. 1-3, the incident analysis component 302 can provide for determining relevant attributes associated with an incident or potential incidents based on the monitored input data 105 that can facilitate identifying incidents or potential incidents by the incident identification component 310 and determining optimal responses for responding to the incidents (e.g., by the surveillance protocol assessment component 210). In this regard, what constitutes an “incent” can be based on a plurality of different factors or incident criteria and vary for different locations and environments based on the rules and regulations defined for the respective locations and environments that govern acceptable and unacceptable user behavior, activity and/or appearances. For example, the incident criteria can relate to, but is not limited to: the behavior, activity and/or appearance (e.g., clothing/attire, objects held/carried, physical appearance, etc.) of a user in solitude; the behavior, activity and/or appearance of a group of users; identities and attributes of the individual or individual involved (e.g., known profiles and history of the individual/individuals, number of individuals, user demographics, user role relative to the environment, user permissions relative to the environment, etc.); other people (not involved in the incident) included in the environment or location (e.g., number of other people and identities and attributes of the other people); and other contextual factors associated with the incident and/or environment (e.g., regarding environmental conditions associated with the environment, objects in the environment, relative positions of the objects, time of day/year, events, weather, etc.).

In various embodiments, the incident analysis component 302 can evaluate all the relevant data associated with an incident or potential incident and/or incident location to determine or infer the relevant attributes for assessing whether an incident is occurring or potentially occurring, assessing the severity of the incident, understanding the context associated with an incident as it changes over time (e.g., in association with continued tracking and assessment of an incident or potential incident) and determining optimal responses to the incident. The analysis performed by the incident analysis component 302 can involve processing the input data 105, as well as accessing and/or processing any additional information associated with an incident or potential incident provided in user profile data 224 (e.g., to obtain relevant information about respective individuals involves or associated with an incident), the incident assessment data 220, the logged user activity data 226, the logged incident data 228, and/or accessible in external databases and/or systems (e.g., incident domain knowledge included in the incident domain knowledge datastore 107, the virtual world system 112 and other systems 114). The analysis performed by the analysis component 302 can also involve interfacing with various applications and/or systems (e.g., internal or external) to perform computationally extensive tasks (e.g., running background checks, performing facial recognition, performing sensory data processing tasks (e.g., image analysis, audio analysis, etc.), running ML models, etc.). In various embodiments, the extent of the analysis performed by the incident analysis component 302, including the tasks selected for performance and the data processing resources allocated to performing these tasks, can be determined and dynamically updated (e.g., by the surveillance protocol assessment component 210) based on need and relativity severity or priority of the totality of all incidents or incident locations being monitored by the surveillance system (as discussed in greater detail infra).

In various embodiments, the incident assessment data 220 can include information that defines what constitutes an “incent” or potential incident for different locations and environments based on known rules and regulations defined for the respective locations and environments that govern acceptable and unacceptable user behavior, activity and/or appearances. For example, the incident assessment data 220 can identify all locations or environments monitored by the surveillance system 120. For each location, the incident assessment data 220 can include incident classification information that classifies potential incidents into defined types or categories respectively represented by unique incident identifiers (e.g., unique incident codes or the like). The incident types or categories can include a wide range of different types of incidents depending on the types of incidents the surveillance system is adapted to monitor and evaluate, including various types of criminal activity and non-criminal activity that violates any predefined rules for an environment and context (e.g., dressing inappropriately, speaking inappropriately, etc.) and/or behavior or activity determined to impose a risk to oneself or others. In some implementations, many of the same incidents can be associated with different locations and environments. However, some locations or environments can have incidents specifically related to those locations or environments. For each incident type (i.e., represented by a unique incident code), the incident assessment data 220 can comprise incident risk criteria for the incident that defines one or more criteria that define the incident. As noted above, incident criteria can relate to, but is not limited to: the behavior, activity and/or appearance (e.g., clothing/attire, objects held/carried, physical appearance, etc.) of a user in solitude; the behavior, activity and/or appearance of a group of users; identities and attributes of the individual or individual involved (e.g., known profiles and history of the individual/individuals, number of individuals, user demographics, user role relative to the environment, user permissions relative to the environment, etc.); other people (not involved in the incident) included in the environment or location (e.g., number of other people and identities and attributes of the other people); and other contextual factors associated with the incident and/or environment (e.g., regarding environmental conditions associated with the environment, objects in the environment, relative positions of the objects, time of day/year, events, weather, etc.).

In accordance one or more embodiments, the incident identification component 310 can determine whether an incident is occurring based on whether and/or to what degree the one or more incident criteria defined for an incident is satisfied. For example, in some implementations, the incident identification component 302 can identify an incident as occurring based on all of the incident criteria defining the incident being satisfied (e.g., which may include one or more criterion), and identify a potential incident as based on some of the incident criteria defining the incident being satisfied. To this end, the analysis performed by the incident analysis component 302 can be based (at least initially) on processing the input data 105 and other relevant data associated with an incident location and/or incident to determine or infer the corresponding incident criteria. The analysis can be triggered by the monitoring component 204 (as discussed above) and thereafter regularly and/or continuously updated for ongoing incidents or potential incidents based on identification thereof. In other embodiments, the incident analysis component 302 can be configured to continuously process all input data 105 received for historical incident location based on the relative severity of incidents attributed to the historical incident locations.

In some embodiments, the incident assessment data 220 can be generated and regularly updated using ML and AI (e.g., by the artificial intelligence component 214) based on analysis of the logged user activity data 226, the logged incident data 228, and incident domain knowledge (e.g., included in the incident domain knowledge datastore 107 correlating user activities, behaviors and attributes in different environments/locations and contexts to defined incident types. For example, in some embodiments, the artificial intelligence component 214 can generate one or more classification models tailored to different incidents and/or locations to classify incidents or potential incidents according to defined incident types or categories based on analysis of the logged user activity data 226, the logged incident data 228, and incident domain knowledge (e.g., included in the incident domain knowledge datastore 107 correlating user activities, behaviors and attributes in different environments/locations and contexts to defined incident types).

The activity/context analysis component 304 can analyze the user activity/context data 101 associated with a particular location and person (or group of people) to determine information regarding user behaviors, activities and attributes, environmental conditions represented in the data for assessing relative to the incident criteria defined for different incidents and/or locations/environments. As noted above, this can involve using automated data processing technologies to interpret sensory data received from security monitoring devices and correlating the sensory data (e.g., image data, audio data, motion data, and other sensory data) to defined human behaviors, activities, attributes and environmental conditions (e.g., using object detection/recognition technologies, facial recognition technologies, motion recognition technologies, gesture recognition technologies, voice to text translation technologies, and so on). The activity/context analysis component 304 can also process user health data and/or activity data received from wearable devices to correlate the data to health states, mental states, and/or user behaviors, activities, gestures, motions, and so on. In some embodiments, one or more of the data processing tasks or functions can be included in the incident assessment data 220 (e.g., as computer-executable instructions, algorithms, models, etc.) and executed by the activity/analysis component 304 using one or more dedicated processors and/or processing components of the processing unit 216. In other embodiments, one or more of these data processing tasks or functions can be performed by external processing engines and called by the activity/context analysis component 304 as needed.

The activity/context analysis component 304 can also identify and extract relevant information associated with user identities represented in the user activity/context data 101 (e.g., including the non-conforming or potentially non-conforming individual or group of individuals and other individuals associated with the environment). The user identities can be determined based on registration to UE associated with the individual or individuals at the incident location, using facial recognition, and/or indicated in an incident report. Relevant information associated with a user identity can be provided in their corresponding user profile data 224, logged user activity data 226, logged incident data 228, and/or provided or extracted from external sources (e.g., background checking systems, health systems, social medial systems etc.). Such information can include (but is not limited to) information regarding their demographics (e.g., age, gender, height, weight, ethnicity, occupation, job title, family/friends, etc.), permissions associated with different environments or locations, criminal background, incident history, activity history, schedule, medical/health history, and the like.

In some embodiments, the activity/context analysis component 304 can also employ AI and/or ML analysis of the user activity/context data 101 (e.g., performed or facilitated by the artificial intelligence component 214) in association with processing the data to determine or infer information regarding user behaviors, activities and attributes, and environmental conditions.

The report analysis 306 can similarly analyze received incident reports (e.g., included in incident report data 103) to determine information regarding user behaviors, activities and attributes, environment and context represented in the incident reports for assessing relative to the incident criteria defined for different incidents and/or locations/environments. For example, the report analysis component 306 can process text data included in the incident reports using NLP to extract relevant information associated with an incident or potential incident and the individual or individuals involved. Such information can vary depending on the extent of the reports, and may include (but is not limited to) information identifying or indicating a type of an incident reported, a location of the incident, information describing the individual or individuals involved, information describing the behavior or activity of the individual or individuals involved (i.e., the non-conforming or potentially non-conforming behavior), information describing the environment, and information describing the context of the incident. In some embodiments, incidents reports can include image data and/or audio data capture of the person or persons involved in the incident and/or the incident environment. With these embodiments, the report analysis component 306 can direct the activity/context analysis component 304 to process the image and/or audio data as described above to generate the corresponding relevant information regarding user behaviors, activities and attributes, environment and context represented in the image/audio data.

The report analysis component 306 can also aggregate incident reports and corresponding information extracted therefrom) associated with the same incident or incident location. In association with aggregating incident reports, the report analysis component 306 can also determine information regarding a number of corroborating reports (e.g., performing fact checking) received for a same incident or incident location, frequency of received reports for a same incident, and validity of the reports. In some embodiments, the report analysis component 306 can evaluate the credibility of respective users providing incident reports in association with determining the validity and weight of the respective incident reports. With these embodiments, the credibility rating component 314 can perform a user credibility rating function that comprises regularly determining and updating user credibility ratings based on the validity of their respective reports received over time for past incidents (e.g., as determined based on logged incident data 228). In some implementations, the credibility rating component 316 can also determine user credibility ratings based on user trust or credibility information provided by external sources (e.g., external user trust scoring systems, social media sources, and so on). Information defining users' credibility rating can be associated with respective profiles of the users in user profile data 224. In some embodiments, the reward component 320 provide rewards or incentives to user for submitting incident reports, such as discounts on subscription services provided by the communication network 110 provider, discounts on user equipment hardware and/or software upgrades, and the like.

In some embodiments, the incident identification component 310 can also identify incident and potential incidents based on the number and/or frequency of received incident reports corroborating a same incident and the validity (or credibility) associated with the respective reports. For example, the incident identification component 302 may determine a potential incident based on the number of corroborating reports being below a threshold number and raise the incident classification to an actual incident based on the number of reports exceeding a threshold. In another example, the incident identification component 302 may determine a potential incident or actual incident based on an average measure of validity or credibility associated with the respective reports associated with the same incident being above or below a threshold measure. The incident assessment data 220 can further define report criteria related to number of corroborating reports, frequency of corroborating reports, validity/credibility requirements and respective thresholds that control classifying an incident as a potential incident or an actual incident. The report criteria can vary for different types of incidents, locations and/or environments.

The incident identification component 310 can further identify and characterize incidents and potential incidents based on a combination of the corresponding user activity/context data 101 and the incident report data 103. In this regard, the incident identification component 302 can aggregate and analyze the totality of all information received related to an incident or potential incident at a location or environment in association with identifying and classifying incidents and potential incidents.

The severity analysis component 308 can further determine one or more measures of severity of identified incidents and potential incidents or incident locations. In some embodiments, the one or more measures of severity can be based on the type of an incident and predefined severity levels associated with different types of incidents and/or incident locations (e.g., as defined in the incident assessment data 220 and/or provided in the incident domain knowledge). The predefined severity levels can be based on known risks associated with the respective types of incidents and/or incident locations (e.g., including injury/damage to oneself, to others, to property, financial costs and other costs and other foreseeable risks) while accounting for the totality of information surrounding an incident and the context of the incident (e.g., including individual or individuals involved, others present in the environment that may be impacted, and various other contextual factors). The predefined severity levels can also be based on historical incidents associated with respective locations (e.g., number of incidents, type of incidents, risks and costs associated with the indents, etc.).

For example, in association with determining and classifying historical incident locations, the incident assessment component 208 can characterize some locations as historical incident locations based on known associations of the locations with incidents or a high risk of incidents in the past. For example, certain environments may be known to have a higher rate or risk/rate of incidents based on known risks associated with the locations (e.g., attributed to the natural landscape, weather, activities performed at the locations, etc.) historical user activity at the locations, such as certain neighborhoods, buildings, event locations, crowded areas (e.g., airports, stadiums), certain natural environments (e.g., dangerous hiking trails, rapid waters, etc.) and so on. The incident assessment component 208 can employ AI and ML techniques (e.g., performed or facilitated by the artificial intelligence component 214) to facilitate identifying, classifying and characterizing historical incident locations based on analysis of the historical information (e.g., logged incident data 228) and additional information regarding incidents associated with the locations provided by various sources. In association with identifying and classifying historical incident locations, the severity analysis component 308 can further determine risk levels associated with the respective historical locations that account for the number of incidents, frequency of the incident types of the incidents, and risks and costs associated with the indents.

Information identifying the historical incident locations and their respective risk levels can be included in the incident assessment data 220 and employed by the severity analysis component 308 in association with determining the one or more measures of severity associated with newly identified incidents or potential incidents associated with those locations (or similar locations). For example, in some implements, the predefined severity levels associated with different incident types and/or incident locations can account for the historical risk levels associated with the respective historical locations and the known risks associated with the incidents and/or the historical locations. In other embodiments, the one or more measures of severity can include separate measures pertaining to an incent severity level and a historical location risk level. Still in other embodiments, the severity analysis component can perform a risk assessment associated with each incident or potential incident as the are detected and monitored to determine known and foreseen risks associated with the incident or potential incident and probability of occurrence of the respective risks. The severity analysis component 308 can further determine overall risk scores associated with the incidents or potential incidents based on the totality of the risks, the probabilities of occurrence of the respective risks and individual severities of the respective risks. The one or more measure of severity can include the overall risk scores.

The one or more measures of severity can also account for the number, frequency and credibility of corroborating incident reports received. The one or more measure of severity can also be determined or inferred (e.g., by the artificial intelligence component 214) based on logged incident data 228 and/or incident domain knowledge data based on learned correlations between same or similar incidents associated same or similar environments or locations (e.g., historical incident locations) and historical risks associated with the incidents. As applied to potential incidents, the one or more measures of severity can also account for the degree to which the incident one or more of the defined incident criteria for the corresponding incident is satisfied as well as different weights applied to respective criteria. The one or more measures of severity can also be based on a forecasted probability of escalation of an incident to a more severe incident classification and/or based on the probability of escalation of a potential incident to an actual incident.

In this regard, the incident analysis component 302 can analyze all received and relevant information about an incident or potential incident to understand what the incident entails, who is involved, level of severity of the incident, the risks associated with the incident, the context of the incident, and so on, to facilitate determining an optimal game plan for responding to the incident. This evaluation and characterization of respective incidents can incorporate predefined rules, algorithms and/or models, including ML and AI algorithms/models (e.g., provided in the incident assessment data 220). In this regard, the incident identification component 302 can also employ AI and ML techniques (e.g., performed by the artificial intelligence component 214) to facilitate identifying, classifying and characterizing incident locations based on analysis of the relevant user/activity context data 101, incident report data 103, logged user activity data 226 correlating incidents at different locations and contexts with observed user behaviors, activities and/or attributes, logged incident data 228 for past incidents, and domain knowledge correlating various parameters correlating user activities, behaviors and attributes in different environments/locations and contexts to defined incident types.

The incident ranking component 310 can further rank respective incidents or incident locations based on respective types of incidents associated with the locations and respective severities of the incidents. The respective severities of the incidents can be based on the one or more measure severity measures discussed above and/or account for the various factors discussed above with respect to the severity analysis (e.g., predefined severity levels associated with respective incident types and/or incident locations, predefined risk levels associated with historical incident locations, known or foreseen risks associated with respective incidents and incident locations, probability of occurrence of the risks, overall risk scores, probability of escalation of an incident or potential incident, and so on). As described in greater detail below, these rankings can be used to determine how to optimally allocation resources of the system 100 (e.g., including network resources of the communication network 110 and computer processing resources of surveillance system 120 used in association with performing surveillance tasks, including data processing tasks (e.g., associated with the incident assessment component 208, and additional surveillance tasks associated with the surveillance protocol assessment component 210 and the surveillance protocol execution component 212 discussed infra). In this regard, the rankings can reflect a measure of priority of the respective incident locations with respect to allocation of the systems resources (e.g., higher priority incident locations receiving priority allocation of the available resources with respect to amount and/or quality). The incident ranking component 310 can further regularly and dynamically update the rankings to account for changes in the escalation and/or de-escalation of the incidents as they are progressively monitored and assessed.

In this regard, in one or more embodiments, based on (and/or in response to) a determination that an incident is occurring or potentially occurring at a location by the incident identification component 310, the incident report component 316 can generate an active incident case file for the incident or potential incident. The active incident case file can be included in the logged incident data 228 and aggregate all relevant information received for the incident and determined by the surveillance system 120 about the incident with timestamps providing a timeline of the progression of the incident or potential incident over time. For example, the active incident case file can include all (or relevant portions thereof) information characterizing the incident determined by the incident analysis component 302 and the ranking component 312 and information regarding surveillance responses determined and executed surveillance system 120 (e.g., by the surveillance protocol execution component 212). The incident tracking component 312 and/or the monitoring component 204 can actively monitor and track any additional input data 105 received by the system related to the incident or potential incident represented in the active case file. In this regard, the incident analysis component 302 can continue to assess and characterize the incident (e.g., in real-time or substantially real-time) based on reception of new relevant input data 105 monitored and received for the incident or potential incident, which can include responses executed by the surveillance system 120 tailored to minimize or prevent the incident or escalation of an incident into an actual incident as well as the results of the responses. The incident ranking component 312 can similarly regularly reassess and recalculate respective incident rankings based on changes in the severity analysis. The incident identification component 310 can further continue to re-evaluate changes in the incident information relative to the incident criteria to determine changes in the status of the incident from being considered an incident or potential incident to being considered a non-incident (e.g., due to the incident or potential incident being successfully remediated or otherwise ending). The incident tracking component 314 can also track changes in the status and progression of an incident or potential incident based on the tracked and logged information in the active incident case file to facilitate determining when an incident has been remediated or has otherwise ended.

Based on a determination that an incident or potential incident has been remediated or has otherwise ended, the incident tracking component 314 can close the active incident case file for the incident or potential incident. The incident report component 318 can further generate an incident report for the incident or potential incident summarizing and/or aggregating all relevant information determined and/or received (e.g., user activity/context data 101 including image/audio data, incident reports and associated text/image/audio data, etc.) about the incident or potential incident. In some embodiments, the incident report component 318 can store incident reports in the logged incident data 228. Additionally, or alternatively, depending on the nature of the incident (e.g., incident type and severity (e.g., criminal verses non-criminal, the incident location, how the incident “ended,” the individual or individuals involved, etc.), the incident report component 318 can provide the incident report (e.g., via the communication component 230) to one or more designated authoritative entities. For example, as applied to criminal incidents, the incident report may be used as evidence in a criminal investigation. The incident report component 318 can further control permissions regarding what entities can access certain incident reports stored in the logged incident data 228 (or anther suitable storage location) and/or specific components of the incident reports based on the nature of the corresponding incidents, the contents of the reports and other criteria. In some embodiments, the incident report component 318 can further remove (e.g., delete or otherwise remove) incident reports and/or specific components of the incident reports (e.g., image data, video files, audio files, etc.) from the logged incident data 228 (or another suitable storage location) after passage of defined amount of time, and/or based on occurrence of other events or conditions (e.g., completion of a criminal investigation or the like).

FIG. 4 presents an example surveillance protocol assessment component 210 in accordance with one or more embodiments of the disclosed subject matter. The surveillance protocol assessment component 210 can include response assessment component 402, resource allocation assessment component 404 and surveillance protocol generation component 406, all of which can correspond to computer-executable components.

With reference to FIGS. 1-4, the surveillance protocol assessment component 210 can determine optimal game plans or surveillance protocols for responding to respective incidents or potential incidents identified by the incident assessment component 208 (and in some implementations the monitoring component 204). The optimal or targeted surveillance protocols can be tailored to each incident and/or incident location and account for the totality of factors surrounding the incident determined by the incident analysis component 302. The optimal or targeted surveillance protocols can include a variety of different responses related to monitoring incident locations and corresponding incidents associated with the locations and performing actions that facilitate minimizing occurrence of the corresponding incidents (and/or risks associated therewith) based on the incident types, severities and/or and various other factors related to the respective incidents individually (e.g., location, context of the individual or individuals involved (e.g., identities, known profiles and history of the individual/individuals, number of individuals, user demographics, etc.), other individual involves, risk and probability of occurrence of the risks, probability of escalation or occurrence of the incident, the amount and validity of received incident reports about the incident, environmental conditions, other contextual factors, and so on).

The optimal or targeted surveillance protocols can also account for the totality of all active incidents or potential incidents (e.g., corresponding to incidents and potential incidents with active incident case files) being monitored by the surveillance system 120 in a manner that allocates resources of the system 100 (e.g., physical and logical resources) based on priority and/or severity (e.g., determined based on the rankings) and need. The optimal or targeted surveillance protocols can also account for allocating resources related to monitoring historical incident locations based on relative risk levels associated with these locations even when active incidents or potential incidents are not occurring. The surveillance protocol assessment component 210 can further regularly or continuously update the targeted surveillance protocols for respective incidents and/or incident locations to account for changes in the escalation and/or de-escalation of the incidents as they are progressively monitored.

To facilitate this end, in one or more embodiments, the response assessment component 402 can assess respective incident or potential incidents individually to determine one or more surveillance responses for the respective incidents tailored to each incident and/or incident location that accounts for the totality of factors surrounding the incident determined by the incident analysis component 302 (e.g., incident type, incident severity, incident location, whether the incident corresponds to an actual incident or a potential incident, probability of escalation of the incident, individual or individuals involved, other individuals at or near the incident location, environmental conditions, and various other factors discussed herein). In some embodiments, the one or more responses can account for all conceivable suitable responses for each incident assuming unlimited system resources are available for responding to each incident. This assessment can involve evaluating predefined responses or response protocols (e.g., defining optimal or preferred surveillance responses and/or required surveillance responses) for different incident types and/or incident locations, incident severities, and incident contexts defined in the surveillance protocol assessment data 222. The assessment can also involve utilization of ML and AI (e.g., performed or facilitated by the artificial intelligence component 214) to determine surveillance responses based on information included in the incident domain knowledge datastore 107, logged user activity data 226 and logged incident data 228 regarding optimal responses performed for same or similar incidents and/or incident locations and contexts.

The surveillance responses can include essentially any task or function performed or facilitated by the surveillance system 120 and/or the communication network 110 related to monitoring user activity at incident locations, identifying and characterizing incidents, minimizing or preventing incidents and associated risks, and remediating incidents or potential incidents. In various embodiments, one or more of the surveillance responses can be considered “surveillance services” provided by the surveillance system.

In this regard, the surveillance responses or surveillance services can involve tasks related to tailoring capture and provision of user activity/context data 101 from one or more security monitoring devices in association with actively monitoring an active incident or active potential incident and/or historical incident location, generally referred to herein as monitoring responses. In some embodiments, as applied to an incident or potential incident in the real-world environment 102, the monitoring responses can include determining (e.g., by the response assessment component 402) one or more optimal security monitoring device or devices to capture and provide additional user activity/context data 101 for a particular incident based on the incident location, the relative position of the individual or individuals involved in the incident or potential incident at the incident location, the movement pattern and mobility state of the individual or individuals, the available security monitoring devices at or near the incident location, the relative to position/location of the security monitoring devices within the incident location or environment, the respective types of the security monitoring devices (e.g., cameras, audio recording devices, motion detection devices, etc.), and the capabilities of the respective security monitoring devices. For example, depending on the relative position of an offending individual (e.g., the individual or individual associated with the behavior, activity, appearance etc. for which an incident or potential incident is based) within an incident location and the movement pattern or trajectory of the individual, the response assessment component 402 can determine which security monitoring devices are relevant to capturing data about the individual (e.g., cameras providing the best perspective and other sensory devices along the individuals trajectory), which may include all of the available security monitoring devices or a subset thereof.

The monitoring responses can also include selectively activating and deactivating security monitoring devices. For example, the response assessment component 402 can determine what security monitoring devices to activate and/deactivate based on need (e.g., relative position of the devices to the individual or group of individuals, trajectory of the individual or group of individuals, and the type and severity of the incident), which may include all or a subset of the available security monitoring devices at or near an incident location. The monitoring responses can also include adding additional security monitoring devices (e.g., flying in drones with cameras to fill blind spots and/or follow and individual). For example, the response assessment component 402 can whether additional security monitoring devices are needed and where (e.g., relative position) based on need (e.g., relative position and distribution of existing security monitoring devices at the incident location, relative position of the devices to the individual or group of individuals, trajectory of the individual or group of individuals, and the type and severity of the incident). The monitoring responses can also include remotely controlling one or more security monitoring devices with respect to device operating parameters and settings (e.g., related to data capture rate, data capture quality, data capture type, zoom levels, volume levels, etc.), and remotely controlling device position, orientation (e.g., view angle as applied to cameras) and movement (e.g., with respect to drone cameras and other security monitoring devices attached to remotely controllable mobile machines/vehicles). For example, the response assessment component 402 can determine how to control operating parameters, settings, position, orientation and movement of one or more security monitoring devices to capture the optimal audio/visual data of the offending individual or individual based on need (e.g., relative position of the devices to the individual or group of individuals, trajectory of the individual or group of individuals, and the type and severity of the incident, etc.).

In association with determining the monitoring responses, the response component 402 can also determine optimal and/or required data transmission quality, reliability and rate parameters for (i.e., scheduling parameters) for the communication of data between the security monitoring devices and network equipment of the communication network 110 (i.e., wireless connection uplink/downlink parameters, transmission quality parameters, transmission rate parameters, reliability parameters, etc.) based on need (e.g., incident type and severity, whether the incident corresponds to an actual incident or potential incident, mobility state of the offending individual/individuals, etc.).

The surveillance responses can also involve tasks related to tailoring processing the user activity information provided by security monitoring devices and processing user provided incident reports by the incident analysis component 302 in association with analyzing the user activity data to identify and characterize incidents. For example, based on the incident location, the type of the incident, the severity of the incident, and the various other factors, the response assessment component 402 can determine optimal or preferred models/algorithms to run by the incident analysis component 302, databases to access, and third-party services to call (e.g., criminal background checking services, facial recognition/identity verification services), and determine an optimal and/or required allocation of computer processing resources to utilize in association with performance of the respective processing tasks (e.g., with respect to amount, type, speed, power, etc.).

The surveillance responses can also relate to obtaining incident reports including identifying relevant users in an environment to request provision of incident reports comprising information about a potential or detected incident based on need (e.g., incident type, incident severity, amount of incident reports already received, degree of correspondence between the reports, credibility of the existing reports, information included in the existing reports, etc.). For example, in association with determining an optimal surveillance protocol for responding to a potential incident or incident the response assessment component 402 can identify and select relevant users to provide incident report information (e.g., additional incident reports and/or new incident reports) about the incident (e.g., descriptive text, image data (e.g., video, live streaming video feeds, audio data, etc.) based on their relative location (e.g., as a function of the location of their UE location) to the incident location and/or activity (i.e., offending user or users) within the incident location, their UE capabilities (e.g., provided in device status data 115), their user equipment battery levels (e.g., provided in device status data 115), their user equipment connectivity status to the communication network 110 (e.g., provided in device status data 115), reporting credibility (e.g., provided in their user profile data 224), and other relevant information about the users that may make them more or less suitable for providing information about the incident (e.g., demographic information, relationships/correlations with the offending user or users, role of the user in the environment/location (e.g., employee, visitor, home owner, etc.), preferences of the user, and so on). The surveillance system can further send (e.g., via communication component 230 and surveillance protocol execution component 212) the selected users requests (i.e., to user equipment of the respective users) for the corresponding incident reports via the communication network 110. In some embodiments, the response assessment can also determine an optimal and/or required allocation of network resources to utilize in association with obtaining additional incident reports and/or a measure of priority associated with obtaining additional incident reports, and/or one or more measure of transmission quality, reliability, rate and speed to utilize in association with configuring/scheduling communication of data between the UE and the NE in association with obtaining the reports and the corresponding data (e.g., applying prioritized scheduling to obtain reports from the selected equipment to ensure optimal transmission and reliability). In this regard, the response assessment component 402 can determine how to control reception of the requested information via the communication network 110 in a prioritized manner in association with determining and controlling optimal scheduling parameters used to communicate data between the security monitoring devices and network equipment of the communication network (i.e., wireless connection uplink/downlink parameters, transmission quality parameters, transmission rate parameters, reliability parameters, etc.).

The surveillance responses can also include sending notifications and alerts to UE 106 via the communication network 110 regarding detected incidents. In this regard, the response assessment component 402 can determine the appropriate entities to notify, timing of notification and the contents (i.e., the information disclosed) of the notifications. Information controlling the appropriate entities to notify, the timing of the notifications and the contents of the notifications can be included in the surveillance protocol assessment data 222, user profile data and/or, determined using AI and/or ML, and be based on the incident location, the incident type, the severity of the incent, the individual and/or individual involved, the probability of escalation of the incident, other individuals assorted with the incident location, and various other factors. For example, in some embodiments, the response assessment component 402 can determine whether and when to send notifications to UE of offending individuals informing them they have been flagged as a person of interest and being actively monitored (e.g., via surveillance protocol execution component 212 and communication component 230). The response assessment component 402 can also determine and recommend actions or behaviors for the offending user or user to perform that can minimize or prevent an incident and/or its associated risks and include these recommendations in the notifications. The surveillance responses can also include sending (e.g., via surveillance protocol execution component 212 and communication component 230) notifications to other uses in the incident environment altering them about the detected incident or potential incident and provide information/recommendations regarding appropriate responsive actions precautions to take. For example, based on the incident location, the incident type, the severity of the incent, the individual and/or individual involved, the probability of escalation of the incident, and various other factors, the response assessment component 402 can determine an preferred or required response involves monitoring (e.g., via monitoring component 204) user movement and location (e.g., based on respective movement and/or location of their user equipment) to detect presence of users within or near an incident location or environment (e.g., relative to a defined distance threshold), and notify the users accordingly (e.g., sending notifications to users informing them that they are located at or near environment associated with an incident or potential incident and include relevant information about incident or potential incident). In some embodiments, the response assessment component 402 can be configured to apply this type of response for all incident locations (including historical incident locations) and potential incident locations. The surveillance responses can also include notifying other relevant entities regarding an incident, such as friends, family members, caregivers, etc. associated with the offending individual or individuals (e.g., via notification sent to user equipment and/or social media platforms), relevant authorities and emergency personnel, and/or any relevant entity that may perform a role related to minimizing or preventing the incident (e.g., notify bar owners in the area not to further serve an intoxicated individual flagged by the system).

The surveillance responses can also include remotely controlling vehicles, remotely controlling physical access points (e.g., locking/opening doors, adapting access security protocols), remotely controlling other relevant internet of things (IoT) devices in a manner that facilitates minimizing or preventing and incident and/or associated risks. The surveillance responses can also include integrating with third-party systems to perform relevant actions determined to minimize or prevent incidents and/or their associated risks (e.g., integrating with finance systems to prevent usage of financial accounts for specific purchases such as preventing an intoxicated person from purchasing alcohol, blocking offending users from access to certain virtual environments, etc.) and various other responses that can be performed or facilitated by the surveillance system via the communication network 110 to minimize or prevent incidents and/or their associated risks.

In this regard, some or all of the surveillance responses that can be included in the optimal targeted surveillance protocols can involve utilizing various surveillance services performed by and/or facilitated by the surveillance system 120 via the communication network 110 using resources physical and logical resources of the communication network 110. The resources can include logical and/or physical resources including and/or associated with network equipment, user equipment and security monitoring devices (e.g., including those already deployed at the incident locations and additional security monitoring device that may deployed depending on the security monitoring protocol applied). In some embodiments, the surveillance system 120 itself can be owned/operated by the communication network provider and employ physical and/or logical resources of the communication network (e.g., computer processing resources, computer storage resources, etc.) to perform the various processing task associated with corresponding surveillance services. Thus, in various embodiments, in association with determining the targeted surveillance protocols and associated surveillance services utilized, the resource allocation assessment component 404 can determine how to optimally allocate the available resources of the system 100 for performing the surveillance responses based on the context and surveillance service needs associated with the respective locations and incidents as the incidents arise.

For example, the resource allocation assessment component 404 can determine how to allocate respective amounts and respective speeds of respective computer processing hardware utilized by surveillance system 120 and/or the communication network 110 in association with performing the respective surveillance response determined by the response assessment component 402 (e.g., including data processing services associated and data communication services associated with the incident assessment component 208 and the surveillance protocol assessment component 210). In another example, the resource allocation assessment component 404 can determine optimal scheduling parameters (e.g., a transmission rate parameter, a latency level parameter, and a reliability level parameter, a quality parameter, etc.) that control a communication protocol associated sending user activity information by the security monitoring devices and/or user equipment (e.g., in association with incident reports) the network equipment. For instance, in one example use case, in association with determining one or more surveillance responses to include in an optimal targeted surveillance protocol, the response assessment component 404 can select one or more UE 106 located at an incident location near the individual or group of individuals involved in an incident and request provision of streaming video content of the incident from the respective UE 106 (e.g., at the control of their respective users). The surveillance resource allocation assessment component 404 can further determine optimal scheduling parameters for configuring wireless communication of the streaming video between the UE 106 and the corresponding network AP to ensure optimal and reliable transmission of the video (e.g., with respect to an uplink latency value, a reliability value, etc.). In another example, the resource allocation assessment component 404 can determine security monitoring device performance information regarding an optimal number of the security monitoring devices to activate, respective rates of data capture by the security monitoring devices and respective qualities of the data capture by the security monitoring devices in association with actively monitoring an incident and/or incident location.

The optimal resource allocations can further account for the totality of all incent locations and associated incidents being monitored by the surveillance system in manner that prioritizes resource distribution and allocation based on need, severity and priority of the incidents (e.g., determined based on the rankings determined by the incident ranking component 312). In this regard, the resource allocation assessment component 404 can further evaluate the available system resources (e.g., using corresponding information included in the network resource data 111 and the device scheduling data 113) and determine respective demands of the system resources (e.g., including type, amount and timing parameters) for performing the respective surveillance responses for each incident or potential incident accounting for response protocols in place for historical incident locations without active incidents. In various embodiments, the resource allocation assessment component 404 can determine an optimal allocation of the available system resources in to perform the one or more surveillance responses determined by the response assessment component 402 for all of the respective incidents and/or incident locations (e.g., the active incident cases, the active potential incident cases, and the historical incident locations) based on priority and/or severity and need while also accounting for defined rules and constraints regarding the optimization associated with predefined response requirements associated with different incident types and/or incident locations, users and/or different incident contexts (e.g., defined in the surveillance protocol assessment data 222). For example, in one or more embodiments, the resource allocation assessment component 404 can determine an optimal allocation of the available system resources to perform respective surveillance responses for the incidents or incident locations based on the rankings determined by the incident ranking component 312. The resource allocation assessment component 404 can also determine the optimal allocation of the available system resources to perform based on the preferred or required data processing parameters and/or data communication parameters associated with the individual respective surveillance responses determined for the respective incidents.

The surveillance protocol generation component 406 can further determine and generate optimal targeted surveillance protocols for all of the active incident, active potential incident and historical incident locations that include the respective surveillance responses determined by the response assessment component 402 and that further include the optimal resource allocations determined by the resource allocation assessment component 404. In this regard, the (final) optimal targeted surveillance protocols generated by the surveillance protocol generation component 406 can define one or more surveillance responses or surveillance service to be performed and/or facilitated by the surveillance system 120 in association with responding to active incidents and/or active potential incidents detected or identified by the monitoring component 204 and/or the surveillance protocol assessment component 210. The (final) optimal targeted surveillance protocols and further define respective allocations of resource of the system 100 (e.g., logical and physical resources) to be utilized in association with performing the one or more surveillance responses and defining time configurations that control timing of execution of the respective surveillance responses. In some embodiments, the optimization assessment can also involve utilization of ML and AI (e.g., performed or facilitated by the artificial intelligence component 214) to determine optimal responses, response timing configurations and optimal resource allocations, based on information included in the incident domain knowledge datastore 107, logged user activity data 226 and logged incident data 228 regarding optimal responses performed for same or similar incidents and/or incident locations and contexts under same or similar resources constraints.

The surveillance protocol execution component 212 can further execute and/or control execution or implementation of the targeted surveillance protocols determined by the surveillance protocol generation component 406.

FIG. 5 presents an example surveillance protocol execution component 212 in accordance with one or more embodiments of the disclosed subject matter. The surveillance protocol execution component 212 can perform and/or control performance of the optimal, targeted surveillance protocols determined by the surveillance protocol assessment component 210 in association with responding to active incidents and potential incident and monitoring historical incident locations. To facilitate this end, the surveillance protocol execution component 212 can include management component 502, reporting component 504, augmented reality component 506, resource allocation control component 508, virtual reality system control component 510, device control component 512 and other systems control component 514 (all of which can correspond to computer-executable components).

With reference to FIGS. 1-5, in various embodiments, the management component 502 can manage and control execution of data processing tasks involved the optimal targeted surveillance protocols by the incident assessment component 208. The resource allocation control component 508 can also control allocation of processing resources of the surveillance system 120 in accordance with the corresponding resource allocations determined for the respective tasks by the resource allocation assessment component 404.

The surveillance protocol responses can also include reporting information regarding detected incidents or potential incidents as well as incident reports to one or more entities (e.g., individual involved in the incident, other entities associated with the incident environment, emergency services, etc.). The reporting component 504 can provide for sending this information to the appropriate entities in the form of reports, notifications and/or alerts (e.g., via the communication component 230). For example, the reporting component 504 can send notifications or alerts to individual (e.g., at their respective UE 106) the regarding presence in an incident location and the relevant information regarding about the incident or incidents occurring or historically associated with the incident location. In some embodiments in which the individuals are wearing or an AR device, augmented reality component 506 can further facilitate identifying the person or persons involved in an incident (e.g., the person or persons performing a non-conforming behavior, activity or appearance attribute) via their AR device. For example, the augmented reality component 506 can facilitate generating AR overlay data indicating the person or persons involved on the AR device display in when the person or person involved is within a viewing perspective of the AR device wearer. The reporting component 504 can also send alerts or notification to the offending individual or individuals notifying them regarding they have been identified as a person of interest (e.g., based on their activity, behavior and/or appearance or another factor amounting to an incident or potential incident) and are being actively monitored. The reporting component 504 can also notify other relevant entities associated with an incident location. In some implementations, notification to other entities can include recommended actions for performance by the other entities to minimize or prevent an incident (e.g., informing local bar owners not to serve an over intoxicated individual). The reporting component 504 can also send requests to selected UE 106 for the provision of incident reports and/or specific information to include in the incident reports (e.g., video, audio, text information, etc.).

The resource allocation control component 508 can interface with the resource management system 508 and instruct the resource management system 118 to perform allocation of communication system resources (e.g., physical and/or logical resources) in accordance with the optimal targeted surveillance protocols determined by the surveillance protocol assessment component 210. In this regard, based on instructions received from the resource allocation control component 508, the resource management system 118 can apply the optimal scheduling parameters associated with the respective protocols and the respective devices (e.g., UE 106, IoT devices 108 and NE 104 involved) in accordance with respective communication service parameters determined for performance of respective responses associated with the respective incidents (e.g., regarding data communication rate parameters, communication quality parameter, latency parameters, reliability parameters, etc.).

The virtual reality system control component 510 can interface with the virtual world system 112 to perform surveillance responses related to virtual reality incident locations or environments. These can include sending notifications and alerts in the same or similar manner as applied to real-world locations. The virtual reality system responses can also include controlling access permissions to worlds, deactivating user accounts, freezing user accounts, and the like. For instance, in one example use case, based on incident corresponding to a user's avatar attire being considered inappropriate for a particular environment, an appropriate surveillance response may include sending the user a warning notification instructing the user to change the avatar's attire. In another example, based on the incident corresponding to an avatar for a first user physically attacking a second user's avatar, the surveillance response may include temporarily suspending the first user's account. The other systems control component 514 can control task performed by other systems, including posting to social media, running background checks, running credibility checks, interfacing with financial systems to cut of certain financial account usage permissions, and so on. The device control component 512 can remotely control operations of devices of the system 100 connected to the communication network in association with performing surveillance responses, including controlling operating parameter configurations of security monitoring devices, remotely controlling position, orientation and/or movement of security monitoring devices, activating/deactivating security monitoring devices and remotely controlling other IoT device 108, (e.g., locks, doors access configurations, security access configurations, lighting and cooling systems, shutting down equipment, etc.).

Referring back to FIG. 2, many operations of the surveillance system 120 described herein can involve utilization of artificial intelligence and machine learning facilitated by the artificial intelligence component 214. To facilitate this end, the artificial intelligence component 214 can perform learning with respect to any and all of the data received by the surveillance system 120 (e.g., input data 104), stored by the computing surveillance system 120 (e.g., incident assessment data 220, surveillance protocol assessment data 222, user profile data 224, logged user activity data 226, logged incident data 228), generated by the surveillance system 120 (e.g., output data 119, or surveillance protocol response data 117) and accessible to the surveillance system 120 (e.g., in the incident domain knowledge datastore 107, the network datastore 109 and at various external systems coupled to the communication network 110). Hereinafter, any information received by the surveillance system 120, generated by the surveillance system 120, stored by the surveillance system 120, and/or accessible to the surveillance system 120 is collectively referred to as “collective machine learning data.”

It should be appreciated that artificial intelligence component 214 can perform learning associated with the collective machine learning data explicitly or implicitly. Learning and/or determining inferences by the artificial intelligence component 214 can facilitate identification and/or classification of different patterns associated with the collective machine learning data, determining one or more rules associated with collective machine learning data, and/or determining one or more relationships associated with the collective machine learning data that influence determinations and inferences by the monitoring component 204, the incident assessment component 208 and the surveillance protocol assessment component 210. The artificial intelligence component 214 can also employ an automatic classification system and/or an automatic classification process to facilitate identification and/or classification of different patterns associated with the collective machine learning data, determining one or more rules associated with collective machine learning data, and/or determining one or more relationships associated with the collective machine learning data that influence determinations and inferences by the monitoring component 204, the incident assessment component 208 and the surveillance protocol assessment component 210. For example, the artificial intelligence component 214 can employ a probabilistic and/or statistical-based analysis (e.g., factoring into the analysis utilities and costs) to learn one or more patterns associated with the collective machine learning data, determining one or more rules associated with collective machine learning data, and/or determining one or more relationships associated with the collective machine learning data that influence determinations and inferences by the monitoring component 204, the incident assessment component 208 and the surveillance protocol assessment component 210. The artificial intelligence component 214 can employ, for example, a support vector machine (SVM) classifier to facilitate learning patterns associated with the collective machine learning data, determining one or more rules associated with collective machine learning data, and/or determining one or more relationships associated with the collective machine learning data that influence determinations and inferences by the monitoring component 204, the incident assessment component 208 and the surveillance protocol assessment component 210.

Additionally, or alternatively, the artificial intelligence component 214 an employ other classification techniques associated with Bayesian networks, decision trees and/or probabilistic classification models. Classifiers employed by the artificial intelligence component 214 can be explicitly trained (e.g., via a generic training data) as well as implicitly trained (e.g., via observing user behavior, receiving extrinsic information). For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

In an aspect, the artificial intelligence component 214 can utilize in part inference-based schemes to facilitate learning one or more patterns associated with the collective machine learning data, determining one or more rules associated with collective machine learning data, and/or determining one or more relationships associated with the collective machine learning data that influence determinations and inferences by the monitoring component 204, the incident assessment component 208 and the surveillance protocol assessment component 210. The machine learning component 602 can further employ any suitable machine-learning based techniques, statistical-based techniques and/or probabilistic-based techniques. The artificial intelligence component 214 can additionally or alternatively employ a reduced set of factors (e.g., an optimized set of factors) to facilitate generating one or more machine learning models configured to perform automated inferencing tasks related to the incident assessment component 208 and the surveillance protocol assessment component 210. For example, the artificial intelligence component 214 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the artificial intelligence component 214 can perform a set of machine learning computations associated with collective machine learning data. For example, the artificial intelligence component 214 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations. Any rules, patterns, and/or correlations learned by the artificial intelligence component 214 with respect to the collective machine learning data can further be stored in the by the computing system (e.g., in storage 218 and/or memory 232), applied by the artificial intelligence component 214 to define, and/or update/refine the incident assessment data 220, the surveillance protocol assessment data 222, the user profile data 224 and/or to generate one or more machine learning models configured to perform automated inferencing tasks related to the incident assessment component 208 and the surveillance protocol assessment component 210.

FIG. 6 illustrates a high-level flow diagram of an example computer-implemented process 600 that facilitates detecting and minimizing social and virtual threats using a communication network in accordance with one or more embodiments of the disclosed subject matter. At 602, process 600 comprises identifying, by a system comprising a processor (e.g., system 100 and/or surveillance system 12), incident locations associated with respective incident risks based on respective user activities associated with the incident locations being determined to satisfy an incident risk criterion (e.g., via monitoring component 204 and/or incident assessment component 208). For example, the incident locations can include incident locations associated with incidents detected at any real-world or virtual location being monitored by the system in real-time, including historical incident locations. In this regard, the incident risks refer to actual or potential incidents detected by the monitoring component 204 and/or the incident assessment component 208, including historical incident risks associated with historical incident locations. At 604, based on the identifying, process 600 further comprises determining, by the system, targeted surveillance protocols for the incident locations (e.g., by the surveillance protocol assessment component 210) comprising determining the targeted surveillance protocols based on respective types of the respective incident risks associated with the incident locations and respective severities of the respective incident risks, wherein utilizing the targeted surveillance protocols comprises utilizing respective surveillance services (e.g., corresponding to surveillance responses) facilitated by resources of a communication network (e.g., processing resources of the surveillance system 120 and/or logical and/or physical resources of the communication network 106, wherein the physical resources can include NE 104, IoT devices 108, and in some implementations, UE 106). At 606, method 600 further comprises controlling, by the system, performance of the targeted surveillance protocols utilizing the respective surveillance services and the resources (e.g., via surveillance protocol execution component 212).

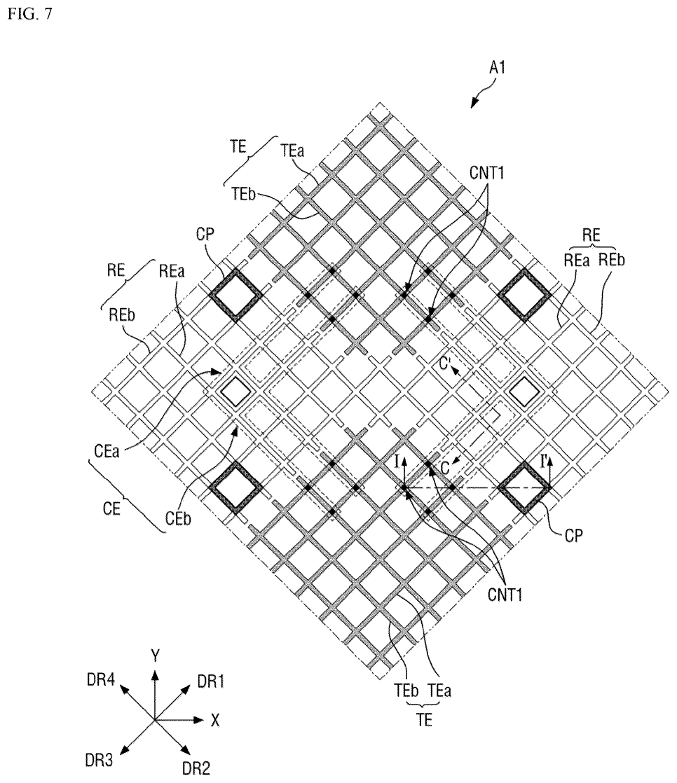

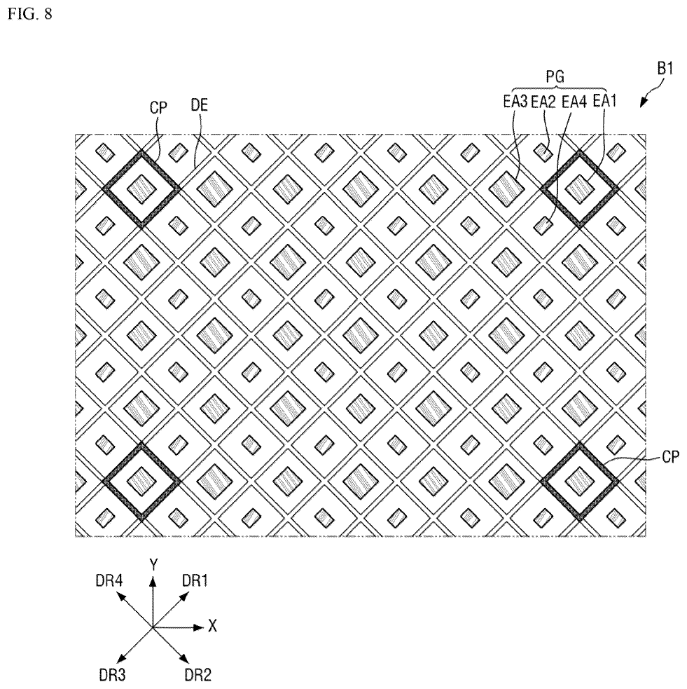

FIG. 7 illustrates a high-level flow diagram of another example computer-implemented process 700 that facilitates detecting and minimizing social and virtual threats using a communication network in accordance with one or more embodiments of the disclosed subject matter. At 702, process 700 comprises identifying, by a system comprising a processor (e.g., system 100 and/or surveillance system 12), incident locations associated with respective incident risks based on respective user activities associated with the incident locations being determined to satisfy an incident risk criterion (e.g., via monitoring component 204 and/or incident assessment component 208). For example, the incident locations can include incident locations associated with incidents detected at any real-world or virtual location being monitored by the system in real-time, including historical incident locations. In this regard, the incident risks refer to actual or potential incidents detected by the monitoring component 204 and/or the incident assessment component 208, including historical incident risks associated with historical incident locations. At 704, method 700 comprises ranking, by the system, the incident locations based on respective types of the respective incident risks associated with the incident locations and respective severities of the respective incident risks (e.g., by the incident ranking component 312).

At 706, based on the identifying, process 700 further comprises determining, by the system, targeted surveillance protocols for the incident locations (e.g., by the surveillance protocol assessment component 210) comprising determining the targeted surveillance protocols based on the ranking, the respective types of the respective incident risks, and the respective severities of the respective incident risks, comprising determining an allocation of resources of a communication network for performance of surveillance responses associated with the targeted surveillance protocols based on the ranking. At 708, method 700 further comprises controlling, by the system, performance of the respective surveillance responses by the communication network in accordance with the allocation (e.g., via surveillance protocol execution component 212).

One or more embodiments can be a system, a method, and/or a computer program product at any possible technical detail level of integration. The computer program product can include a computer readable storage medium (or media) having computer readable program instructions thereon for causing a processor to carry out one or more aspects of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language or similar programming languages, and machine-learning programming languages such as like CUDA, Python, Tensorflow, PyTorch, and the like. The computer readable program instructions can execute entirely on the user's computer, partly on the user's computer, as a stand-alone software package, partly on the user's computer and partly on a remote computer or entirely on the remote computer or server using suitable processing hardware. In the latter scenario, the remote computer can be connected to the user's computer through any type of network, including a local area network (LAN) or a wide area network (WAN), or the connection can be made to an external computer (for example, through the Internet using an Internet Service Provider). In various embodiments involving machine-learning programming instructions, the processing hardware can include one or more graphics processing units (GPUs), central processing units (CPUs), and the like. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In order to provide additional context for various embodiments described herein, FIG. 8 and the following discussion are intended to provide a brief, general description of a suitable computing environment 800 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 8, the example environment 800 for implementing various embodiments of the aspects described herein includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures can also be employed as the processing unit 804.

The system bus 808 can be any of several types of bus structure that can further interconnect to a memory bus (with or without a memory controller), a peripheral bus, and a local bus using any of a variety of commercially available bus architectures. The system memory 806 includes ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also include a high-speed RAM such as static RAM for caching data.

The computer 802 further includes an internal hard disk drive (HDD) 814 (e.g., EIDE, SATA), one or more external storage devices 816 (e.g., a magnetic floppy disk drive (FDD) 816, a memory stick or flash drive reader, a memory card reader, etc.) and a drive 820, e.g., such as a solid state drive, an optical disk drive, which can read or write from a disk 822, such as a CD-ROM disc, a DVD, a BD, etc. Alternatively, where a solid state drive is involved, disk 822 would not be included, unless separate. While the internal HDD 814 is illustrated as located within the computer 802, the internal HDD 814 can also be configured for external use in a suitable chassis (not shown). Additionally, while not shown in environment 800, a solid state drive (SSD) could be used in addition to, or in place of, an HDD 814. The HDD 814, external storage device(s) 816 and drive 820 can be connected to the system bus 808 by an HDD interface 824, an external storage interface 826 and a drive interface 828, respectively. The interface 824 for external drive implementations can include at least one or both of Universal Serial Bus (USB) and Institute of Electrical and Electronics Engineers (IEEE) 1384 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 812, including an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In such an embodiment, operating system 830 can comprise one virtual machine (VM) of multiple VMs hosted at computer 802. Furthermore, operating system 830 can provide runtime environments, such as the Java runtime environment or the .NET framework, for applications 832. Runtime environments are consistent execution environments that allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and settings for an application.

Further, computer 802 can be enable with a security module, such as a trusted processing module (TPM). For instance with a TPM, boot components hash next in time boot components, and wait for a match of results to secured values, before loading a next boot component. This process can take place at any layer in the code execution stack of computer 802, e.g., applied at the application execution level or at the operating system (OS) kernel level, thereby enabling security at any level of code execution.

A user can enter commands and information into the computer 802 through one or more wired/wireless input devices, e.g., a keyboard 838, a touch screen 840, and a pointing device, such as a mouse 842. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 804 through an input device interface 844 that can be coupled to the system bus 808, but can be connected by other interfaces, such as a parallel port, an IEEE 1384 serial port, a game port, a USB port, an IR interface, a BLUETOOTH® interface, etc.

A monitor 846 or other type of display device can be also connected to the system bus 808 via an interface, such as a video adapter 848. In addition to the monitor 846, a computer typically includes other peripheral output devices (not shown), such as speakers, printers, etc.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 852 is illustrated. The logical connections depicted include wired/wireless connectivity to a local area network (LAN) 854 and/or larger networks, e.g., a wide area network (WAN) 856. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired or wireless communication to the LAN 854, which can also include a wireless access point (AP) disposed thereon for communicating with the adapter 858 in a wireless mode.

When used in a WAN networking environment, the computer 802 can include a modem 860 or can be connected to a communications server on the WAN 856 via other means for establishing communications over the WAN 856, such as by way of the Internet. The modem 860, which can be internal or external and a wired or wireless device, can be connected to the system bus 808 via the input device interface 844. In a networked environment, program modules depicted relative to the computer 802 or portions thereof, can be stored in the remote memory/storage device 852. It will be appreciated that the network connections shown are example and other means of establishing a communications link between the computers can be used.

When used in either a LAN or WAN networking environment, the computer 802 can access cloud storage systems or other network-based storage systems in addition to, or in place of, external storage devices 816 as described above, such as but not limited to a network virtual machine providing one or more aspects of storage or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The illustrated aspects of the disclosure may also be practiced in distributed computing environments where certain tasks are performed by remote processing devices that are linked through a communications network. In a distributed computing environment, program modules can be located in both local and remote memory storage devices.

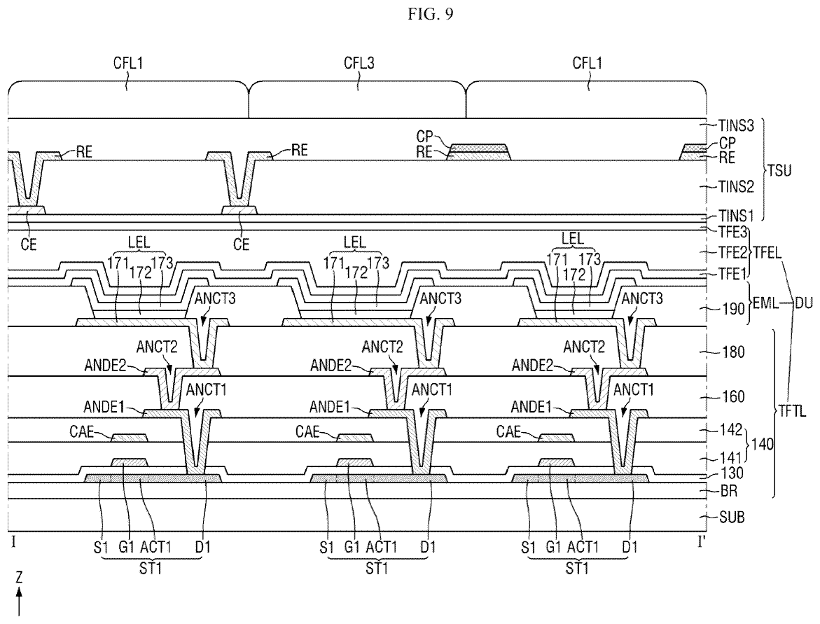

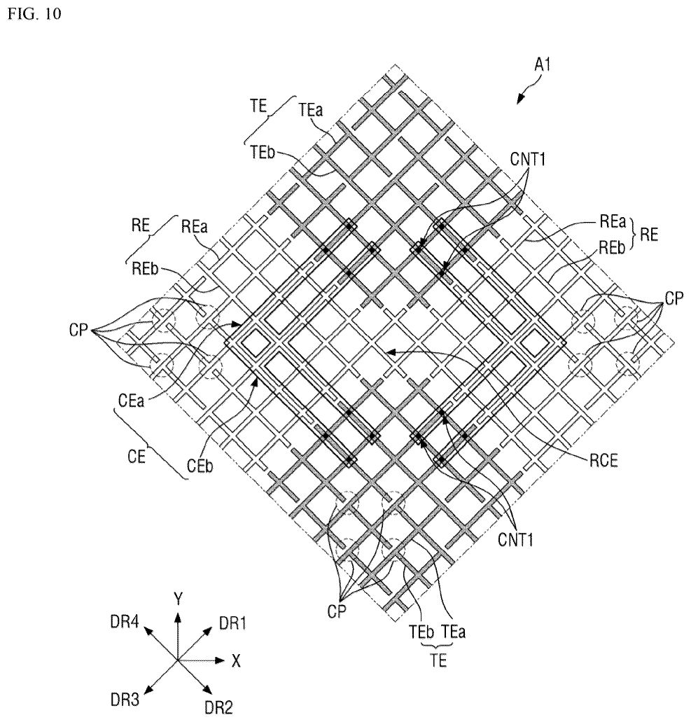

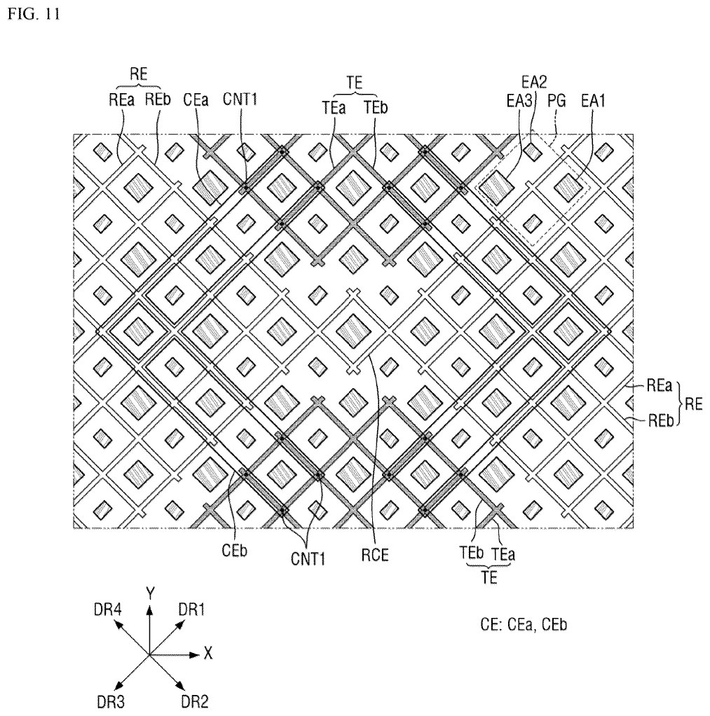

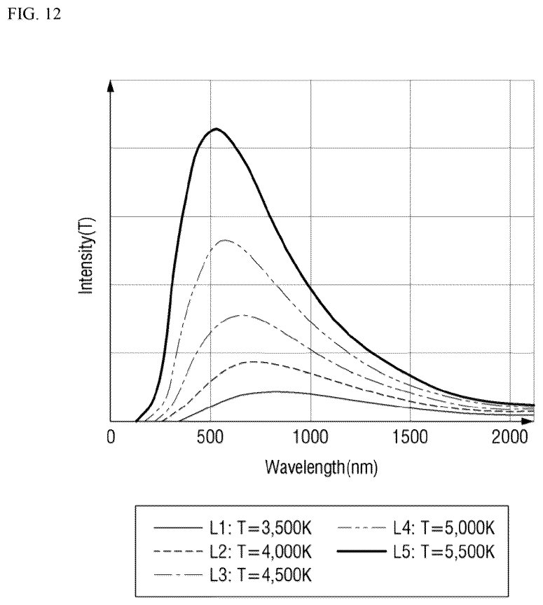

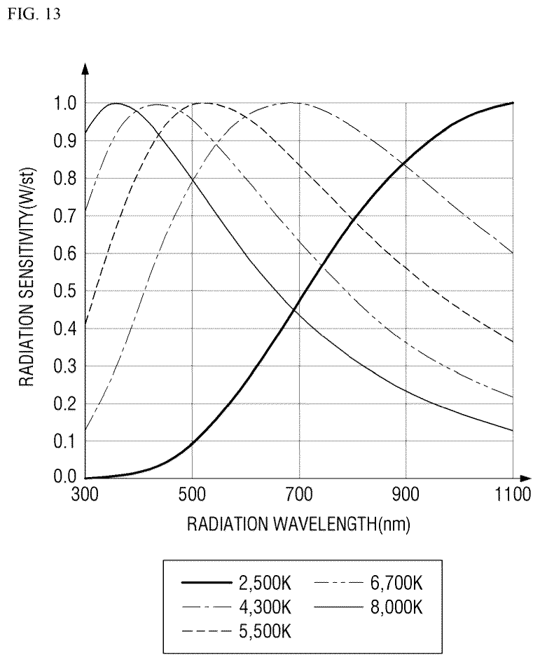

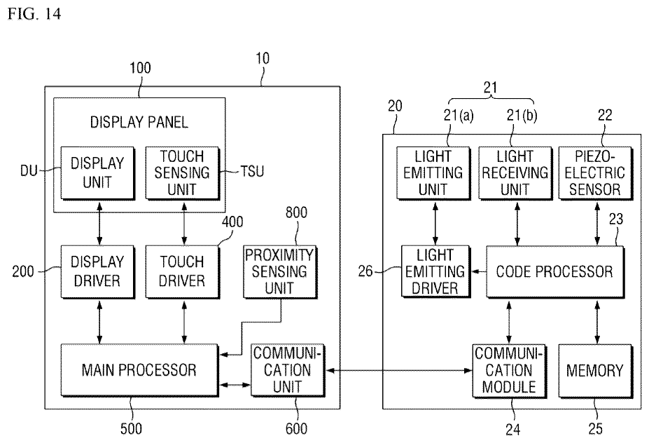

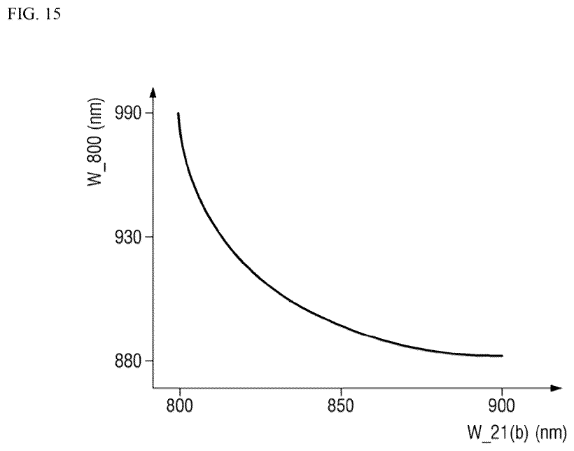

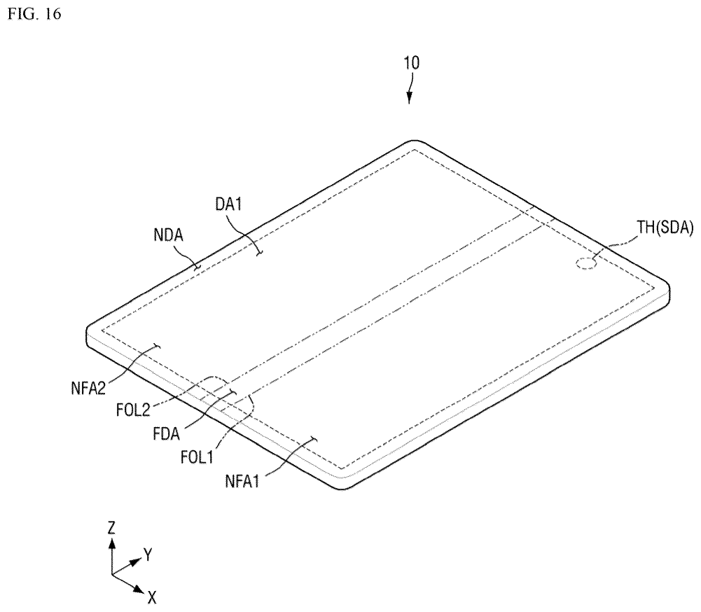

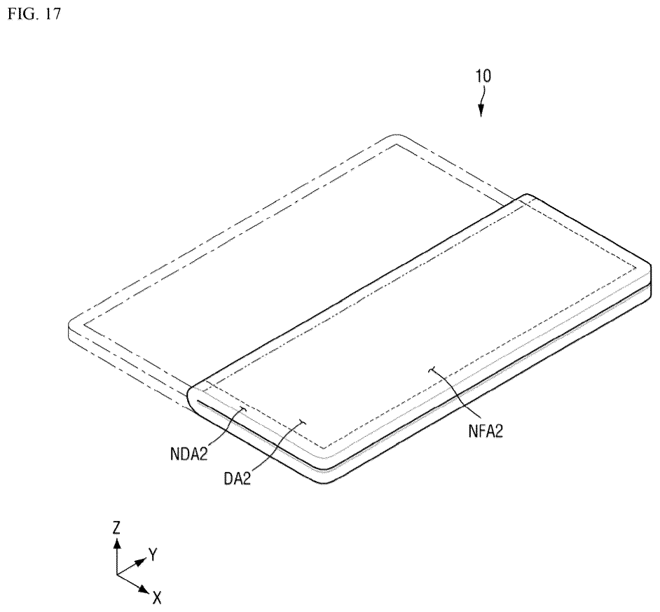

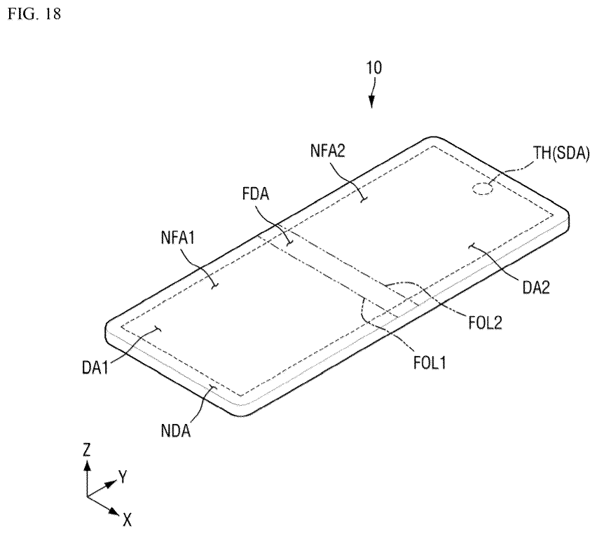

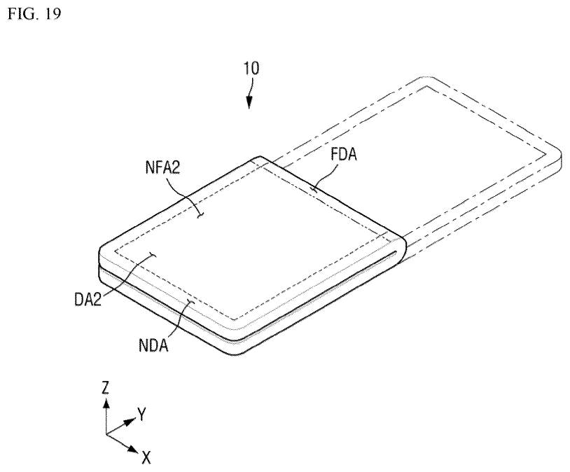

Referring to FIG. 9, there is illustrated a schematic block diagram of a computing environment 900 in accordance with this disclosure in which the subject systems (e.g., system 100, surveillance system 120 and the like), methods and computer readable media can be deployed. The computing environment 900 includes one or more client(s) 902 (e.g., laptops, smart phones, PDAs, media players, computers, portable electronic devices, wearable devices, tablets, and the like). The client(s) 902 can be hardware and/or software (e.g., threads, processes, computing devices). The computing environment 900 also includes one or more server(s) 904. The server(s) 904 can also be hardware or hardware in combination with software (e.g., threads, processes, computing devices). The servers 904 can house threads to perform transformations by employing aspects of this disclosure, for example. In various embodiments, one or more components, devices, systems, or subsystems of system 100, and/or surveillance system 120 can be deployed as hardware and/or software at a client 902 and/or as hardware and/or software deployed at a server 904. One possible communication between a client 902 and a server 904 can be in the form of a data packet transmitted between two or more computer processes wherein the data packet may include healthcare related data, training data, AI models, input data for the AI models, encrypted output data generated by the AI models, and the like. The data packet can include a metadata, e.g., associated contextual information, for example. The computing environment 900 includes a communication framework 906 (e.g., a global communication network such as the Internet, or mobile network(s)) that can be employed to facilitate communications between the client(s) 902 and the server(s) 904.

Communications can be facilitated via a wired (including optical fiber) and/or wireless technology. The client(s) 902 include or are operatively connected to one or more client data store(s) 908 that can be employed to store information local to the client(s) 902. Similarly, the server(s) 904 are operatively include or are operatively connected to one or more server data store(s) 910 that can be employed to store information local to the servers 904.

In one embodiment, a client 902 can transfer an encoded file, in accordance with the disclosed subject matter, to server 904. Server 904 can store the file, decode the file, or transmit the file to another client 902. It is to be appreciated, that a client 902 can also transfer uncompressed file to a server 904 can compress the file in accordance with the disclosed subject matter. Likewise, server 904 can encode video information and transmit the information via communication framework 906 to one or more clients 902.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “subsystem” “platform,” “layer,” “gateway,” “interface,” “service,” “application,” “device,” and the like, can refer to and/or can include one or more computer-related entities or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” or “processing unit” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor; and
a memory that stores executable instructions that, when executed by the processor, facilitate performance of operations, comprising:
identifying incident locations associated with respective incident risks based on respective user activities associated with the incident locations being determined to satisfy an incident risk criterion;
based on the identifying, determining targeted surveillance protocols for the incident locations comprising determining the targeted surveillance protocols based on respective types of the respective incident risks associated with the incident locations and respective severities of the respective incident risks, wherein utilizing the targeted surveillance protocols comprises utilizing respective surveillance services facilitated by resources of a communication network; and
controlling performance of the targeted surveillance protocols utilizing the respective surveillance services and the resources.

2. The system of claim 1, wherein the resources comprise network resources of the communication network and wherein determining the targeted surveillance protocols comprises determining an allocation of the network resources for performance of the surveillance services by the communication network based on the respective types of the respective incident risks respectively associated with the incident locations and the respective severities of the respective incident risks.

3. The system of claim 2, wherein the operations further comprise:
ranking the incident locations based on the type of the respective incident risks respectively associated with the incident locations and the respective severities of the respective incident risks and determining the allocation based on the ranking.

4. The system of claim 3, wherein the controlling comprises:
monitoring the respective user activities at the incident locations; and
updating the ranking based on the monitoring.

5. The system of claim 2, wherein determining the allocation comprises determining respective amounts and respective speeds of respective computer processing hardware utilized by the communication network in association with performing the respective surveillance services.

6. The system of claim 2, wherein the resources further comprise security monitoring devices that capture and send user activity information about the respective user activities at the incident locations to network equipment of the communication network, and wherein determining the allocation comprises determining communication scheduling parameters that control a communication protocol associated with sending the user activity information by the security monitoring devices to the network equipment.

7. The system of claim 6, wherein the communication scheduling parameters comprise at least one of: a transmission rate parameter, a latency level parameter, and a reliability level parameter.

8. The system of claim 6, wherein determining the targeted surveillance protocols further comprises determining security monitoring device performance information regarding a number of the security monitoring devices to activate, respective rates of data capture by the security monitoring devices and respective qualities of the data capture by the security monitoring devices, and wherein the controlling comprises controlling respective activations and respective data capture performances of the security monitoring devices based on the security monitoring device performance information.

9. The system of claim 6, wherein the security monitoring devices comprise respective user equipment associated with respective users at the incident locations.

10. The system of claim 9, wherein determining the targeted surveillance protocols comprises selecting the respective user equipment based on respective battery levels of the respective user equipment and wherein the controlling comprises:
sending respective requests to the respective user equipment requesting capture and provision of the user activity information to the network equipment; and
receiving the user activity information by the network equipment in response to the respective requests.

11. The system of claim 1, wherein the controlling comprises:
sending a notification to a user equipment indicating a presence within an incident location of the incident locations based on detection of the user equipment within the incident location.

12. The system of claim 1, wherein the identifying comprises identifying an incident location of the incident locations based on reception of incident report data indicating a user associated with the incident location is executing a risk behavior or exhibiting a risk attribute.

13. The system of claim 12, wherein the controlling comprises:
actively monitoring, via one or more of the respective devices, user activity of the user based on the reception of incident report data; and
sending a notification directed to a device associated with the user to indicate, to the user, that the user has been flagged as a person of interest based on the risk behavior or the risk attribute and to indicate, to the user, that the user activity of the user is being actively monitored.

14. The system of claim 13, wherein the user comprises a first user, the device comprises a first device, and the notification comprises a first notification, wherein determining the targeted surveillance protocols comprises identifying a second user determined to have a role related to reducing or eliminating the risk behavior or the risk attribute, and wherein the controlling further comprises:
sending a second notification directed to the second device, the second notification:
identifying the first user,
indicating that the first user has been flagged as the person of interest based on the risk behavior or the risk attribute, and
instructing the second user to perform an action determined to reduce or eliminate the risk behavior or the risk attribute in accordance with the role.

15. The system of claim 1, wherein the incident locations comprise a virtual location associated with a virtual world.

16. A method, comprising:
identifying, by a system comprising a processor, incident locations associated with incident risks with based on user activities associated with the incident locations satisfying an incident risk criterion;
determining, by the system, targeted surveillance protocols for the incident locations based on the identifying, comprising determining the targeted surveillance protocols based on respective types of the incident risks associated with the incident locations and respectively severities of the incident risks, wherein the targeted surveillance protocols specify usage of respective surveillance services performed by respective devices connected via a communication network; and
controlling, by the system, respective performances of the targeted surveillance protocols utilizing the respective surveillance services performed by the respective devices.

17. The method of claim 16, wherein determining the targeted surveillance protocols comprises determining an allocation of network resources enabled via the communication network for performance of the respective surveillance services by the respective devices based on the respective types of the incident risks associated with the incident locations and the respective severities of the incident risks, and wherein the respective devices comprises respective user equipment connected via the communication network.

18. The method of claim 17, further comprising:
ranking, by the system, the incident locations based on the respective types of the incident risks associated with the incident locations and the respective severities of the incident risks, wherein determining the allocation comprises determining the allocation based on the ranking;
monitoring, by the system, the user activities at the incident locations; and
updating the ranking based on the monitoring.

19. A non-transitory machine-readable medium, comprising executable instructions that, when executed by a processor, facilitate performance of operations, comprising:
identifying incident locations associated with an incident risk based on user activity associated with the incident locations satisfying an incident risk criterion usable to determine whether a given incident location is associated with the incident risk;
determining targeted surveillance protocols for the incident locations based on the identifying, comprising determining the targeted surveillance protocols based on a type of the incident risk associated with the incident locations and a severity of the incident risk, wherein the targeted surveillance protocols comprise utilizing surveillance services performed by devices that are configured to operate via a communication network; and
controlling performance of the targeted surveillance protocols utilizing the surveillance services performed by the devices.

20. The non-transitory machine-readable medium of claim 19, wherein determining the targeted surveillance protocols comprises determining an allocation of network resources enabled for use via the communication network for performance of the surveillance services by the devices based on the type of the incident risk respectively associated with the incident locations and the severity of the incident risk, and wherein the devices comprises network devices that are configured to operate via the communication network.
